(19) United States
(12) Patent Application Publication
(10) Pub. No.: US 2009/0183317 A1
(43) Pub. Date: Jul. 23, 2009

(54) Detergent or Treatment Agent Portion

(75) Inventors: Frank Meier, Duesseldorf (DE); Matthias Sunder, Duesseldorf (DE); Hermann-Josef Welling, Monheim (DE); Dieter Nickel, Erkrath (DE); Heike Schirmer-Ditze, Duesseldorf (DE)

Correspondence Address: Ratner Prestia, P.O. Box 980, Valley Forge, PA, 19482, US

(73) Assignee: Henkel AG & Co. KGaA, Duesseldorf (DE)

(21) Appl. No.: 12/344,338

(22) Filed: Dec. 26, 2008

Related U.S. Application Data
(63) Continuation of application No. PCT/EP2007/054975, filed on May 23, 2007.

(30) Foreign Application Priority Data
Jun. 27, 2006 (DE) 10 2006 029 840.3

(51) Int. Cl. C11D 17/00

(52) U.S. Cl. 8/137; 510/298; 510/297

(57) ABSTRACT

A dimensionally stable, single-piece detergent or treatment agent portion having a weight of at least 50 g, having a system for controlling the solubility of the detergent or treatment agent. In washing, treating, or rinsing cycles of a washing machine for textiles, a maximum 50 wt % of the detergent or treatment agent portion dissolves or disperses in municipal water (16° d) at a maximum temperature of 20° C. as dissolves or disperses in municipal water (16° d) at a temperature of 50° C., enabling targeted release of the active substances in the portion during the cycles of a washing or treating program using heated water.

### CROSS-REFERENCE TO RELATED APPLICATIONS

This application is a continuation under 35 U.S.C. §§ 120 and 365(c) of International Application PCT/EP2007/054975, filed on May 23, 2007. This application also claims priority under 35 U.S.C. § 119 of DE 10 2006 029 840.3 filed on Jun. 27, 2006. The disclosures of PCT/EP2007/054975 and DE 10 2006 029 840.3 are incorporated by reference in their entirety.

### BACKGROUND OF THE INVENTION

The present invention relates to a dimensionally stable detergent or treatment agent portion having a weight of at least 50 g, a method for producing this detergent or treatment agent portion, a kit comprising the detergent or treatment agent portion and a bag or container, a method for washing and/or treating textiles in an automatic washing machine in which the detergent or treatment agent portion or the kit is used as well as the use of the detergent or treatment agent portion or the kit for automatic metering into the drum of an automatic washing machine for textiles.

Detergents or treatment agents are available for the consumer today in a variety of forms. In addition to powder and granules, this offering also includes, for example, concentrates in the form of extruded or tableted compositions. These solid, concentrated and/or compressed forms are characterized by a reduced volume per dosage unit and thus lower the costs for packaging and shipping. The detergent or treatment agent tablets in particular additionally fulfill the consumer's desire for simplified dosing. The corresponding agents have been described extensively in the state of the art. In addition to the advantages mentioned, compacted detergents or treatment agents also have a number of disadvantages, however. Tableted forms in particular are often characterized by delayed disintegration due to their high compaction and are therefore characterized by delayed release of their ingredients. Numerous technical approaches have been disclosed in the patent literature for resolving this “dispute” between adequate tablet hardness and short disintegration times; at this point, reference is to be made to the use of so-called tablet disintegrants as an example. These disintegration accelerators are added to the tablets in addition to the active detergent or treatment substances, although they themselves do not usually have any active detergent or treatment properties and in this way increase the complexity and costs of these agents.

Solid or liquid detergents or treatment agents have been described to an increasing extent in recent years as alternatives to the particulate or compacted detergents or treatment agents described previously; they have a water-soluble or water-dispersible packaging. These agents, like the tablets, are characterized in that they simplify dosing because they can be dosed into the washing machine together with the repackaging; on the other hand, however, they also at the same time allow fabrication of liquid or powdered detergents or treatment agents which are characterized by better dissolution and more rapid efficacy in comparison with the compacted tablets.

The agents mentioned so far have in common the fact that the consumer must always dose the detergent or treatment agent separately for each wash stage or treatment stage. The tablets, powders, granules, liquids, gels and solid and liquid detergents or treatment agents repackaged in individual portions are consumed completely in the respective wash stage or treatment stage selected.

In the state of the art, however, portions of agents containing the active ingredient for a number of wash stages or treatment stages are also known. According to US 2002/0132752 A1 (Caruthers et al.), such an agent is dosed with the help of a dispenser by dosing a defined amount of water into the dispenser filled with the agent, dissolving one portion of the agent and in this way preparing a concentrated solution of the agent. This concentrated solution is then fed into the cleaning device, e.g., the washing machine, and diluted with more water to form a washing solution, which is brought in contact with the surfaces to be cleaned. An important disadvantage of this technique is that washing machines in which these agents are to be used must have a separate dispensing device, which is not identical to the dispensing compartments customary in Europe.

The solid cleaning agent composition, which is disclosed in the patent application WO 2005/077064 A2 (Ecosafe Technologies L.L.C.) and which is widely used, does not have this disadvantage. This solid agent is added directly to the drum of the washing machine together with the laundry to be washed and then releases the active ingredient over several wash stages. Since the water solubility, i.e., water dispersibility, of the agents thereby disclosed has a low dependence on temperature and therefore the ingredients of the agent are dissolved/dispersed in wash cycles or treatment cycles performed with heated water as well as in the cold water of the rinse cycles, at least the portion of the ingredients dissolved/dispersed in the last rinse cycle as well as their decomposition or conversion products remain on the textiles, which can lead to residues on the fabric and to skin reactions in the consumer during and after contact with the textiles treated in this way. In agreement with this, the published patent application WO 2005/077064 A2 advises against the use of surfactants in the agents disclosed there, supporting this with the property of surfactants of leaving residues on the treated laundry.

Fabrication of a cleaning agent composition—as disclosed in WO 2005/077064 A2—using extra components which must be removed from the textiles by a rinse cycle, however, to prevent residues on the textiles or skin irritation in the consumer is impossible in the case of the agents disclosed there due to their dissolving and dispersing properties.

### DESCRIPTION OF THE INVENTION

The object of the present invention was to overcome the disadvantages of the known detergents or treatment agents. In particular, this should make available a detergent or treatment agent which can be dosed more easily and which can be fabricated with components that should not remain on the textiles because of the formation of residues, damage to fibers with prolonged contact, exacerbation of the color effect of the textiles, unpleasant odors of the components or their products of decomposition, due to possible skin reactions of the consumer in contact with the textiles or for other reasons.

It has now been found that this object can be achieved by a detergent or treatment agent portion, comprising a system for control of the solubility of the portion, causing the detergent or treatment agent portion to release the active ingredient primarily in the detergent or treatment cycles but in a definitely smaller amount in the rinse cycles of an automatic washing machine.

The subject matter of the present patent application is a dimensionally stable one-piece detergent or treatment agent portion having a weight of at least 50 g, comprising a system for control of the solubility of the detergent or treatment agent, such that in the wash cycles, treatment cycles or rinse cycles of a washing machine for textiles, which are performed with water (tap water 16° d) at a temperature of max. 20° C., a maximum of 50 wt %, preferably a maximum of 40 wt %, especially a maximum of 30 wt % and in particular a maximum of 20 wt % of the amount of detergent or treatment agent portion dissolved and/or dispersed by the same portion in water (tap water 16°) at a temperature of 50° C. under otherwise identical conditions is dissolved and/or dispersed per cycle.

A preferred embodiment of the present invention is an inventive detergent or treatment agent portion which has a solubility/dispersibility in water at 15° C. (tap water 16° d) of less than 0.2 g/100 mL water, preferably less than 0.19 g/100 mL water, especially preferably less than 0.18 g/100 mL water and in particular less than 0.17 g/100 mL water, and especially preferably has a solubility/dispersibility in water at 50° C. (tap water 16° d) of more than 0.35 g/100 mL water, especially preferably of more than 0.37 g/100 mL water, preferably between 0.39 g and 1.2 g/100 mL water, especially between 0.41 g/100 mL water and 1.1 g/100 mL water and in particular between 0.43 g and 1.0 g/100 mL water. Such a detergent or treatment agent portion preferably comprises a basic detergent for white textiles and/or colored textiles, sensitive textiles and/or wool.

Another embodiment of the inventive detergent or treatment agent portion that is likewise preferred has a solubility/dispersibility in water at 15° C. (tap water 16° d) of less than 0.1 g/100 mL water, preferably less than 0.09 g/100 mL water, especially preferably less than 0.08 g/100 mL water and in particular less than 0.07 g/100 mL water and especially preferably has a solubility/dispersibility in water at 50° C. (tap water 16° d) of more than 0.12 g/100 mL water, more preferably more than 0.14 g/100 mL water, especially preferably more than 0.16 g/100 mL water and in particular more than 0.18 g/100 mL water. This embodiment preferably comprises an extra component for a basic detergent for white textiles and/or colored textiles and/or wool, preferably a bleaching component, an enzyme component or a finishing component, antimicrobial active ingredients, nonionic surfactants, enzymes or mixtures of these components.

The solubility/dispersibility of a detergent or treatment agent portion is determined by means of a standardized solubility/dispersibility test, which is described in the examples.

The ingredients of water that interfere with the washing process include primarily the elements calcium and magnesium. These alkaline earth minerals determine the quality of the water for cleaning purposes. Calcium and magnesium ions together with soap form sparingly soluble salts, lime soap and magnesium soap. Sparing soluble compounds may also be formed with other anionic surfactants. In addition, sparingly soluble alkaline earth carbonates may also be deposited on the laundry and on the heating rods of the washing machines. Alkaline earth ions are therefore fundamentally unwanted in washing. The sum of the alkaline earth minerals is detected in the form of water hardness (total hardness). Water having a high calcium and magnesium ion content is referred to as being hard, while water with a low calcium and magnesium ion content is considered to be soft. The numerical determination is expressed in the form of degrees of hardness. Within the scope of this text, the hardness of the water used is given in the units customary in Germany, namely degrees of German hardness (° d). Water of 1° d contains 0.178 mmol/L Ca²⁺ and Mg²⁺ ions and/or water which contains 1 mmol/L Ca²⁺ and Mg²⁺ ions has a water hardness of 5.6° d. Iron and manganese ions, which occur in low concentrations in drinking water and surface water, also have an interfering effect in washing. In aqueous solution, they form sparingly soluble salts, which can be identified by their yellow to brown color. The amount of these salts in the tap water used for the solubility test is preferably less than 0.01 mg/100 mL, in particular less than 0.005 mg/100 mL.

The requirement of rapid solubility/dispersibility and/or of rapid disintegration is made of the commercially available detergents or treatment agents in the form of powders, granules or tablets. The active ingredients of these agents should be available at the very beginning of the wash stage or treatment stage for which they were dosed individually, if possible. In the case of tablets, rapid disintegration is achieved, e.g., by adding so-called tablet disintegrants. An opposite task is defined with the preferred detergent or treatment agent portions: they should dissolve/disperse slowly enough so that only the required amount of active ingredient is released per wash stage or treatment stage. The amount of the inventive agent dissolved/dispersed per wash stage or treatment stage should be as constant as possible. Furthermore, the active ingredients should be released mainly, preferably essentially exclusively in those cycles in which they are actually needed.

Within the scope of the present invention, it is provided that the detergent or treatment agent portion has a solubility/dispersibility that is definitely dependent on temperature, so that a sufficient amount of active ingredient is preferably released in the wash cycles or treatment cycles performed with heated water, but preferably as little active ingredient as possible is dissolved/dispersed in the rinse cycles performed with cold water.

A reduced solubility/dispersibility in comparison with the detergents or treatment agents which must be dosed separately per wash stage as well as a solubility/dispersibility that depends greatly on temperature can be achieved with the inventive detergent or treatment agent portions by fabricating the detergent or treatment agent portion with a system for control of the solubility. The system for control of the solubility of the detergent or treatment agent portion is preferably present in an amount of at least 5 wt %, preferably at least 10 wt %, especially preferably at least 15 wt %, most especially preferably in an amount of 20 wt % to 65 wt % and in particular in an amount of 25 wt % to 60 wt %. The system for control of the solubility preferably comprises at least one component which has a softening temperature between 35° C. and 200° C., preferably between 45° C. and 150° C. Alternatively or additionally, the system for control of the solubility preferably includes a component which has definitely different solubilities/dispersibilities in water at 15° C. and 50° C. (see solubility test mentioned above). Of this component in 15° C. water (tap water 16° d) max. 20 wt %, preferably max. 10 wt % and in particular max. 5 wt % of the weight which is dissolved/dispersed by the component in 50° C. water (tap water 16° d) under conditions that are otherwise identical is preferably dissolved/dispersed of this component.

If a system is used for control of the solubility, then of the detergent or treatment portion, at most small amounts of the agent dissolve in the rinse cycle of a wash stage or treatment stage and this small amount is removed from the textiles almost completely with the rinse water, preferably being removed completely. In this way, an inventive detergent or treatment agent portion may also comprise significant amounts of surfactant and/or other components, which should not remain in the textiles, without the consumer having to suffer from skin irritation or haze and residues on the washed and/or treated laundry.

In principle, all compounds having a suitable solubility/dispersion profile may be used in the system for control of solubility. Especially suitable compounds are those from the group of polymers which may also be used in combination with one another.

Suitable polymers are

a) water-soluble nonionic polymers from the group of
a1) polyvinylpyrrolidones,
a2) vinylpyrrolidones/vinyl ester copolymers,
a3) cellulose ethers,

b) water-soluble amphoteric polymers from the group of
b1) alkylacrylamides/acrylic acid copolymers,
b2) alkylacrylamides/methacrylic acid copolymers,
b3) alkylacrylamides/methyl methacrylic acid copolymers,
b4) alkylacrylamides/acrylic acid/alkylaminoalkyl(meth)acrylic acid copolymers,
b5) alkylacrylamides/methacrylic acid/alkylaminoalkyl (meth)acrylic acid copolymers,
b6) alkylacrylamides/methyl methacrylic acid/alkylaminoalkyl (meth)acrylic acid copolymers,
b7) alkylacrylamides/alkyl methacrylate/alkylaminoethyl methacrylate/alkyl methacrylate copolymers,
b8) copolymers of
   b8i) unsaturated carboxylic acids,
   b8ii) cationically derivatized unsaturated carboxylic acids,
   b8iii) optionally other ionic or nonionic monomers,

c) water-soluble zwitterionic polymers from the group of
c1) acrylamidoalkyl trialkylammonium chloride/acrylic acid copolymers and their alkali salts and ammonium salts,
c2) acrylamidoalkyl trialkylammonium chloride/methacrylic acid copolymers and their alkali salts and ammonium salts,
c3) methacroyl ethylbetaine/methacrylate copolymers,

d) water-soluble anionic polymers from the group of
d1) vinyl acetate/crotonic acid copolymers,
d2) vinylpyrrolidone/vinyl acrylate copolymers,
d3) acrylic acid/ethyl acrylate/N-tert-butylacrylamide terpolymers,
d4) graft polymers of vinyl esters, esters of acrylic acid or methacrylic acid alone or in mixture, copolymerized with crotonic acid, acrylic acid or methacrylic acid with polyalkylene oxides and/or polyalkylene glycols,
d5) grafted and crosslinked copolymers from copolymerization of
   d5i) at least one monomer of the nonionic type,
   d5ii) at least one monomer of the ionic type,
   d5iii) of polyethylene glycol and
   d5iv) a crosslinking agent,
d6) copolymers obtained by copolymerization of at least one monomer of each of the three following groups:
   d6i) esters of unsaturated alcohols and short-chain saturated carboxylic acids and/or esters of short-chain saturated alcohols and unsaturated carboxylic acids,
   d6ii) unsaturated carboxylic acids,
   d6iii) esters of long-chain carboxylic acids and unsaturated alcohols and/or esters of the carboxylic acids of group d6ii) with saturated or unsaturated, linear or branched C₈₋₁₈ alcohol,
d7) terpolymers of crotonic acid, vinyl acetate and an allyl ester or methallyl ester,
d8) tetra- and pentapolymers of
   d8i) crotonic acid or allyloxyacetic acid,
   d8ii) vinyl acetate or vinyl propionate,
   d8iii) branched allyl or methallyl esters,
   d8iv) vinyl ethers, vinyl esters or linear allyl or methallyl esters,
d9) crotonic acid copolymers with one or more monomers from the group of ethylene, vinylbenzene, vinyl methyl ether, acrylamide and their water-soluble salts,
d10) terpolymers of vinyl acetate, crotonic acid and vinyl esters of a saturated aliphatic monocarboxylic acid with branching in a position,

e) water-soluble cationic polymers from the group of
e1) quaternated cellulose derivatives,
e2) polysiloxanes with quaternary groups,
e3) cationic guar derivatives,
e4) polymeric dimethyldiallylammonium salts and their copolymers with esters and amides of acrylic acid and methacrylic acid,
e5) copolymers of vinylpyrrolidone with quaternated derivatives of dialkyl aminoacrylate and methacrylate,
e6) vinylpyrrolidone methoimidazolinium chloride copolymers,
e7) quaternated polyvinyl alcohol,
e8) polymers covered by the INCI terms polyquaternium 2, polyquaternium 17, polyquaternium 18 and polyquaternium 27.

In a preferred variant of the process, the system for control of the solubility comprises one or more water-soluble polymers, preferably a material from the group of (optionally acetalized) polyvinyl alcohol (PVAL), polyvinylpyrrolidone, polyethylene oxide, gelatin, cellulose and their derivatives and mixtures.

Within the scope of the present invention, it is preferable for the system for control of solubility to comprise at least proportionally a polyvinyl alcohol in which the degree of hydrolysis amounts to 70 mol % to 100 mol %, preferably 80 mol % to 90 mol %, especially preferably 81 mol % to 89 mol % and in particular 82 mol % to 88 mol %. Polyvinyl alcohols of a certain molecular weight range are preferably used, whereby it is preferable according to the invention that the system for control of the solubility comprises a polyvinyl alcohol whose molecular weight is in the range of 10,000 g·mol⁻¹ to 100,000 g·mol⁻¹, preferably 11,000 g·mol⁻¹ to 90,000 g·mol⁻¹, especially preferably 12,000 g·mol⁻¹ to 80,000 g·mol⁻¹ and in particular 13,000 to 70,000 g·mol⁻¹. The degree of polymerization of such preferred polyvinyl alcohols is between approx. 200 and approx. 2100, preferably between approx. 220 and approx. 1890, especially preferably between approx. 240 and approx. 1680 and in particular between approx. 260 and approx. 1500.

The water solubility of PVAL may be varied by after-treatment with aldehydes (acetalization) or ketones (ketalization). Polyvinyl alcohols which are acetalized and/or ketalized with the aldehyde and/or keto groups of saccharides or polysaccharides or mixtures thereof have been found to be especially preferred and also especially advantageous because of their extremely good cold water solubility. The reaction products of PVAL and starch are extremely advantageous for use here.

Polyvinylpyrrolidones, abbreviated as PVP, can be described by the following general formula:

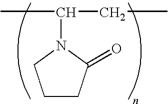

PVPs are prepared by free radical polymerization of 1-vinylpyrrolidone. Commercial PVPs have molecular weights in the range of approx. 2500 g/mol to 750,000 g/mol and are offered as white hygroscopic powders or as aqueous solutions.

Polyethylene oxides, abbreviated PEOX, are polyalkylene glycols of the general formula

H—(O—CH₂—CH₂)ₙ—OH,

which are synthesized industrially by base-catalyzed polyaddition of ethylene oxide (oxirane) in systems which usually contain small amounts of water with ethylene glycol as the initiator molecule. They have molecular weights in the range of approx. 200 g/mol to 5,000,000 g/mol, corresponding to degrees of polymerization n of approximately 5 to >100,000. Polyethylene oxides have an extremely low concentration of reactive hydroxyl end groups and have only weak glycol properties.

Gelatin is a polypeptide (molecular weight approx. 15,000 g/mol to >250,00 g/mol), which is obtained mainly by hydrolysis of the collagen contained in the skin and bone of animals under acidic or alkaline conditions. The amino acid composition of the gelatin largely corresponds to that of the collagen from which it was obtained and varies as a function of its provenience. Use of gelatin as a water-soluble coating material is extremely widespread especially in the form of hard or soft gelatin capsules used in pharmacy. Gelatin is used only to a slight extent in the form of films because of its high price in comparison with the polymers mentioned above.

Materials comprising a polymer from the group of starch and starch derivatives, cellulose and cellulose derivatives, in particular methylcellulose and mixtures thereof are preferred as components of the system for control of the solubility.

Starch is a homoglycan, with the glucose units in an α-glycosidic linkage. Starch is composed of two components having different molecular weights: approx. 20% to 30% linear amylose (mol. wt. approx. 50,000 to 150,000) and 70% to 80% branched chain amylopectin (mol. wt. approx. 300,000 to 2,000,000). In addition, there are also small amounts of lipids, phosphoric acid and cations. Whereas amylose forms long interlinked helical chains with approx. 300 to 1200 glucose molecules due to the bond in position 1,4, the chain in the case of amylopectin branches after an average of 25 glucose building blocks due to a 1,6-bond to form a branching structure with approx. 1500 to 12,000 glucose molecules. In addition to pure starch, starch derivatives obtainable from starch by polymer-like reactions are also suitable. Such chemically modified starches comprise, for example, products of esterifications and/or etherifications in which hydroxy-hydrogen atoms have been substituted. Starches in which the hydroxyl groups have been replaced by functional groups that are not bound by an oxygen atom can also be used as starch derivatives. The group of starch derivatives includes, for example, alkali starches, carboxymethylstarch (CMS), starch esters and ethers as well as amino starches.

Pure cellulose has the formal empirical composition (C₆H₁₀O₅)ₙ and, considered formally, is a β-1,4-polyacetal of cellobiose, which is in turn made up of two glucose molecules. Suitable celluloses consist of approx. 500 to 5000 glucose units and consequently have average molecular weights of 50,000 to 500,000.

Also suitable as a component of the system for control of solubility are fusible substances from the group of fats and/or triglycerides and/or fatty acids and/or fatty alcohols and/or waxes and/or paraffins.

Fat(s) or triglyceride(s) is/are the terms for compounds of glycerol in which the three hydroxyl groups of glycerol are esterified by carboxylic acids. The naturally occurring fats are triglycerides, which usually contain various fatty acids in the same glycerol molecule. By saponification of the fats and subsequent esterification and/or reaction with acyl chlorides, however, synthetic triglycerides in which only one fatty acid is bound are also accessible (e.g., tripalmitin, triolein or tristearin). Natural and/or synthetic fats and/or mixtures of the two are preferred as components of the system for control of solubility.

“Fatty acids” in the present patent application refer to saturated or unsaturated aliphatic carboxylic acids with a branched or unbranched carbon chain. For synthesis of the fatty acids, there are a number of synthesis methods. Whereas the low fatty acids are usually based on oxidation processes starting with alcohols and/or aldehydes as well as aliphatic and/or acyclic hydrocarbons, the higher homologs are usually most readily accessible today by saponification of natural fats. In the meantime, there have been almost unlimited possibilities for varying the fatty acid spectrum in the stored fats of oil plants due to advances made in the field of transgenic plants. Within the scope of the present invention, preferred fatty acids have a melting point which allows processing of these fats in a casting process. Fatty acids having a melting point above 25° C. have proven to be especially advantageous. Preferred components of the system for control of solubility are therefore capric acid and/or undecanoic acid and/or lauric acid and/or tridecanoic acid and/or myristic acid and/or pentadecanoic acid and/or palmitic acid and/or margaric acid and/or stearic acid and/or nonadecanoic acid and/or arachidic acid and/or erucaic acid and/or elaeostearic acid. However fatty acids with a melting point below 25° C. may also be used.

Fatty alcohol is a collective term for the linear, saturated or unsaturated primary alcohols having 6 to 22 carbon atoms obtainable by reduction of the triglycerides, fatty acids and/or fatty acid esters. Fatty alcohols may be saturated or unsaturated, depending on the synthesis process. Myristyl alcohol and/or 1-pentadecanol and/or cetyl alcohol and/or 1-heptadecanol and/or stearyl alcohol and/or erucyl alcohol and/or 1-nonadecanol and/or arachidyl alcohol and/or 1-heneicosanol and/or behenyl alcohol and/or erucyl alcohol and/or brassidyl alcohol are preferred components of the system for control of the solubility.

It has also proven advantageous if the system for control of solubility contains waxes in the inventive detergent or treatment agent portions. Preferred waxes have a melting range between approx. 35° C. and approx. 75° C. In other words, in the present case, the melting range is within the stated temperature interval and does not refer to the width of the melting range. Waxes having such a melting range are also dimensionally stable at room temperature, but they still melt at the temperatures of 30° C. to 90° C. typical of automatic washing machines and are therefore more readily water-dispersible at these temperatures.

“Waxes” are understood to refer to a number of natural or synthetically obtained substances which melt usually at temperatures above 40° C. without decomposing and have a relatively low viscosity at a temperature just slightly above the melting point and are not stringy. They have a consistency and solubility which depend greatly on temperature.

The waxes are divided into three groups, namely natural waxes, chemically modified waxes and synthetic waxes, depending on their origin.

The natural waxes include, for example, vegetable waxes such as candelilla wax, carnauba wax, Japan wax, espartogras wax, suberic wax, guaruma wax, rice germ wax, sugar cane wax, ouricuri wax or montan wax, animal waxes such as beeswax, shellac wax, spermaceti, lanolin or bird rump fat, mineral waxes such as ceresin or ozokerite or petrochemical waxes, such as petrolatum, paraffin waxes or microwaxes.

Chemically modified waxes include, for example, hard waxes, such as montan ester waxes, sassol waxes or hydrogenated jojoba waxes.

Synthetic waxes are usually understood to be polyalkylene waxes or polyalkylene glycol waxes. Compounds from other classes of substances that meet these requirements with regard to softening point may also be used as fusible or softenable substances for the compositions that harden through cooling. For example, higher esters of phthalic acid, in particular dicyclohexyl phthalate, which is available commercially under the brand name Unimoll® 66 (Bayer AG) have proven to be suitable synthetic compounds. Also suitable are synthetically produced waxes from low carboxylic acids and fatty alcohols, e.g., dimyristyl tartrate, which is available under the brand name Cosmacol® ETLP (Condea). Conversely, synthetic or partially synthetic esters of low alcohols with fatty acids from native sources may also be used. For example, Tegin® 90 (Goldschmidt), a glycerol monostearate palmitate, falls in this class of substances. Shellac, e.g., KPS-Dreiring-SP shellac (Kalkhoff GmbH), may also be used.

For example, the so-called wax alcohols may also be counted with the waxes within the scope of the present invention. Wax alcohols are high-molecular water-insoluble fatty alcohols, usually with approx. 22 to 40 carbon atoms. The wax alcohols are used, for example, in the form of wax esters of high-molecular fatty acids (wax acids) as the main component of many natural waxes. Examples of wax alcohols include lignoceryl alcohol (1-tetracosanol), cetyl alcohol, myristyl alcohol or melissyl alcohol. The coating of the solid particles coated according to the invention may optionally also contain lanolin alcohols, which are understood to be triterpenoid alcohols and steroid alcohols, e.g., lanolin, which is available under the brand name Argowax® (Pamentier & Co.), for example.

In another preferred embodiment, the system contains paraffin wax to control solubility (paraffins). Preferably at least 50 wt % of the system for control of the solubility consists of paraffin wax. Especially suitable are paraffin wax contents (based on the total weight of the system for control of the solubility) of approx. 60 wt %, approx. 70 wt % or approx. 80 wt %, but even larger amounts of more than 90 wt %, for example, are especially preferred. In a special embodiment of the invention, the entire system for control of solubility consists of paraffin wax.

Paraffin waxes have the advantage in comparison with the other aforementioned natural waxes within the scope of the present invention that no hydrolysis takes place with them in an alkaline environment (such as that to be expected with the wax esters) because paraffin wax does not contain any hydrolyzable groups.

Paraffin waxes consist mainly of alkanes and small amounts of isoalkanes and cycloalkanes. The amount of alkanes, isoalkanes and cycloalkanes that are solid at ambient temperature (usually approx. 10° C. to approx. 30° C.) and are used in the paraffin wax is preferably as high as possible. The greater the solid wax content of a wax at room temperature, the more usable it is within the scope of the present invention.

Preferred components for the system for control of the solubility are also polyalkylene glycols, preferably polyethylene glycols and polypropylene glycols.

Polymers of ethylene glycol conform to the general formula:

H—(O—CH₂—CH₂)ₙ—OH

where n may assume values between 1 (ethylene glycol) and several thousand. It is conventional in the industry to state the average relative molecular weight after the designation “PEG,” so that “PEG 200” characterizes a polyethylene glycol with a relative molecular weight of approx. 190 to approx. 210. The average relative molecular weight of the polyalkylene glycol(s) is preferably between 200 and 36,000, especially between 200 and 14,000 and especially preferably between 300 and 12,000.

Polypropylene glycols (abbreviated PPG) are polymers of propylene glycol which conform to the general formula

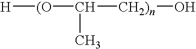

where n may assume values between 1 (propylene glycol) and several thousand. Dipropylene glycol, tripropylene glycol and tetrapropylene glycol in particular, i.e., the representatives in which n=2, 3 and 4 in the formula given above, are of industrial importance here.

Systems for control of the solubility, which contain a nonionic polymer, preferably a polyalkylene glycol, especially a polyethylene glycol and/or a polypropylene glycol are especially preferred, where the amount by weight of polyethylene glycol to the total weight of the system for control of the solubility is preferably between 10 wt % and 90 wt %, especially preferably between 30 wt % and 80 wt % and in particular between 50 wt % and 70 wt %. Especially preferred are systems for control of the solubility which contain more than 92 wt %, preferably more than 94 wt %, especially preferably more than 96 wt %, most especially preferably more than 98 wt % and in particular 100 wt % polyalkylene glycol, preferably polyethylene glycol and/or polypropylene glycol, in particular, however, polyethylene glycol. Systems for control of the solubility which also contain polypropylene glycol in addition to polyethylene glycol preferably have a ratio of the amount by weight of polyethylene glycol to polypropylene glycol between 40:1 and 1:2, preferably between 20:1 and 1:1, especially preferably between 10:1 and 1.5:1 and in particular between 7:1 and 2:1.

Other preferred components of the system for control of the solubility include the nonionic surfactants which are used alone, but especially preferably in combination with a nonionic polymer. Detailed statements regarding the nonionic surfactants that can be used may be found as part of the description of active detergent substances or active treatment substances.

Another class of compounds preferably used in the system for control of the solubility are the sugars, sugar acids and sugar alcohols.

Preferably the monosaccharides, disaccharides and oligosaccharides as well as derivatives and mixtures thereof are used. Glucose, fructose, ribose, maltose, lactose, sucrose, maltodextrin and Isomalt® as well as mixtures of two, three, four or more monosaccharides and/or disaccharides and/or derivatives of monosaccharides and/or disaccharides are especially preferred.

The sugar acids can be used alone or in combination with other substances, e.g., the aforementioned sugars, as components of a preferred liquid releasing agent. Preferred sugar acids include gluconic acid, galactonic acid, mannonic acid, fructonic acid, arabinonic acid, xylonic acid, ribonic acid and 2-deoxyribonic acid as well as their derivatives.

Preferred in mixture with these sugar acids, derivatives or sugar acids, sugars and/or sugar derivatives or alone are compounds from the group of sugar alcohols, preferably mannitol, sorbitol, xylitol, dulcitol and arabitol.

Suitable polyvalent alcohols as components of the system for control of the solubility are compounds having at least two hydroxyl groups. The aggregate state of these compounds at room temperature (20° C.) is solid. Especially suitable polyvalent alcohols include, for example, trimethylolpropane, pentaerythritol as well as the “sugar alcohols,” i.e., the polyhydroxy compounds obtained from monosaccharides by reduction of the carbonyl group. Tetratols, pentatols, hexitols, etc. are differentiated according to the number of hydroxyl groups present in the molecule. Especially suitable sugar alcohols within the scope of the present invention include, for example, threitol and erythritol, adonitol (ribitol), arabitol (previously: lyxitol) and xylitol, dulcitol (galactitol), mannitol and sorbite (glucitol), the latter also being referred to as sorbitol.

Another preferred class of substances that may be used as components of the system for control of the solubility include water-soluble polyurethanes.

Polyurethanes are polyadducts of at least two different monomer types
a di- or polyisocyanate (A) and
a compound (B) having at least two active hydrogen atoms per molecule.

The polyurethanes used as a solution or suspension and/or dispersion are obtained from reaction mixtures in which at least one diisocyanate and at least one polyethylene glycol and/or at least polypropylene glycol is present.

In addition, the reaction mixtures may also contain other polyisocyanates. The presence of other diols, triols, diamines, triamines, polyetherols and polyesterols in the reaction mixtures—and therefore also the polyurethanes—is also possible. The compounds with more than two active hydrogen atoms are usually used only in small amounts in combination with a great excess of compounds with two active hydrogen atoms. The polyurethanes contain diisocyanates as monomer building blocks. Predominantly hexamethylene diisocyanate, toluene 2,4-diisocyanate and toluene 2,6-diisocyanate, methylene-4,4′-di(phenyl isocyanate) and in particular isophorone diisocyanate are used as the diisocyanates. The polyurethanes also contain diols as polymer building blocks, these diols originating at least proportionately from the group of polyethylene glycols and/or polypropylene glycols. In preferred embodiments of the present invention, the polyurethanes have molecular weights of 5000 g·mol⁻¹ to 150,000 g·mol⁻¹, preferably 10,000 to 100,000 g·mol⁻¹ and in particular 20,000 g·mol⁻¹ to 50,000 g·mol⁻¹.

In summary, the system for control of the solubility of the detergent or treatment agent preferably contains one or more components from the group of polyethylene glycols, polypropylene glycols, polybutyrates, polyvalent alcohols, sugars, polyurethanes, natural waxes, chemically modified waxes, synthetic waxes, wax alcohols, wax esters, paraffins, polyvinyl alcohols, polyacrylic acids and their derivatives, gelatin and celluloses. Especially preferred are systems for control of the solubility which comprise paraffins and/or polyethylene glycols. Also suitable components of a system for control of the solubility of the inventive detergent or treatment agent portions are amorphous silica and potassium silicate.

In comparison with the known powders, granules, tablets and portioned liquids or gels which are consumed in a single wash stage or treatment stage and which release all the active ingredients already at the start of washing or treatment program, the inventive detergent or treatment agent portions have a higher performance.

The detergent or treatment agent portion preferably has a weight of 75 g to 1500 g, preferably 100 g to 1000 g, especially preferably from 200 g to 850 g and in particular from 300 g to 700 g. The detergent or treatment agent portion is preferably in the form of prisms, preferably a cube or an ellipsoid, especially a spheroid, in particular a flattened or collapsed spheroid or a sphere. The shape of the detergent or treatment agent portion especially preferably corresponds to a collapsed spheroid having the geometric characteristics of a rugby ball. In a very preferred embodiment, the detergent or treatment agent portion is spherical and is thus in the form of a sphere. The detergent or treatment agent portion preferably releases active ingredient over 2 to 60 wash stages or treatment stages, especially preferably over 4 to 50 and in particular over 6 to 40 wash stages or treatment stages in an automatic washing machine for textiles.

In a preferred embodiment, an inventive detergent or treatment agent portion comprises a basic detergent for white textiles and/or colored textiles, sensitive textiles and/or wool.

Basic detergents for white textiles and/or colored textiles are known to the consumer in Europe under the term all purpose detergent and/or colored detergent. Basic detergents for wool are offered commercially under the term wool detergents. Within the scope of these embodiments, the term “basic detergent for sensitive textiles” should include all agents suitable for washing and for treating special textiles. Examples of corresponding basic detergents include fine detergents, curtain detergents, detergents for black textiles, detergents for white textiles, which should not be brought in contact with all-purpose detergents, detergents for synthetic textiles, etc. Suitable ingredients of basic detergents will be listed in a later passage.

An inventive detergent or treatment agent portion especially preferably comprises:
5 to 15 wt % preferably 7 to 13 wt % anionic surfactant,
0.5 to 7 wt % preferably 1 to 5 wt % nonionic surfactant,
12 to 45 wt % preferably 15 to 40 wt % builders including cobuilders,
0 to 0.6 wt %, preferably 0.05 to 0.3 wt % enzymes,
optional bleach activators and/or optical brighteners, and
30 to 70 wt % preferably 35 to 65 wt % of a system for control of the solubility.

If the detergent or treatment agent portion comprises a basic detergent, then the portion preferably has a weight of 150 g to 1000 g, preferably from 250 g to 900 g, especially preferably from 300 g to 800 g and in particular from 350 g to 700 g. The detergent or treatment agent portion comprising a basic detergent for white textiles and/or colored textiles, sensitive textiles and/or wool especially preferably contains significant amounts of surfactant, e.g., at least 6 wt % anionic surfactant, preferably at least 9 wt % anionic surfactant.

If a detergent or treatment agent portion includes one of the aforementioned basic detergents, then it preferably releases the active ingredient over 2 to 40 wash stages or treatment stages, preferably 4 to 30 wash stages or treatment stages and in particular 6 to 20 wash stages or treatment stages in an automatic washing machine for textiles. Within the scope of the present text, the term “wash stage” is understood to include any washing program that can be set on an automatic washing machine, such as a boiling wash, colored wash, fine wash, hand wash and wool wash program, each at different temperatures. The term “treatment stage” includes the programs of an automatic washing machine, the main purpose of which is not to clean textiles but instead to finish and treat textiles. Examples of treatment stages include starching, rinsing, dyeing, soaking, etc. Wash stages or treatment stages each include the actual wash cycle or treatment cycle(s) as well as rinse cycles. Preferably 40 g to 150 g of the detergent or treatment agent portion containing a basic detergent is dissolved/dispersed per wash stage or treatment stage, especially 50 g to 140 g, especially preferably 60 g to 130 g and in particular 70 g to 120 g.

A preferred subject matter of the present invention is a dimensionally stable one-piece detergent or treatment agent portion having a weight of at least 50 g, comprising a basic detergent for white textiles and/or colored textiles, sensitive textiles and/or wool, which contains enzyme and/or substantial quantities of surfactant, preferably at least 6 wt % surfactant.

In another preferred embodiment, an inventive detergent or treatment agent portion comprises an extra component for a basic detergent for white textiles and/or colored textiles, sensitive textiles and/or wool, preferably a bleaching component, an enzyme component or a finishing component for textiles, antimicrobial active ingredients and nonionic surfactants, enzymes and mixtures of these components.

The term “finishing components for textiles” is understood to refer to components which are absorbed onto the fibers of the textile and thus produce a change in the properties of the textile surfaces. Examples of suitable finishing components includes softening compounds such as cationic surfactants, clays, cationic polymers and polysiloxanes. Soil-repellent polymers, preferably from the group of terephthalic compounds, which are preferably sulfonated, phobizing agents or impregnation agents, antistatics, optical brighteners, UV foam stabilizers, skin care components and compounds such as silicone derivatives which improve the water absorbency, the rewettability of the treated textiles and facilitate ironing of the treated textiles. The finishing components for textiles here also include fragrance compositions, wrinkle-preventing agents, graying inhibitors, shrinkage preventing agents, fluorescent agents and dye transfer inhibitors.

Suitable extra components for basic detergents will be listed later.

An inventive detergent or treatment agent portion comprising an extra component for a basic detergent preferably has a weight of 65 g to 1000 g, preferably from 75 g to 800 g, especially preferably from 85 g to 600 g and in particular from 95 g to 500 g. A detergent or treatment agent portion, which comprises an extra component for a detergent or treatment agent preferably contains at least 20 wt %, preferably at least 30 wt % and in particular at least 40 wt % bleaching agent, at least 0.5 wt %, preferably at least 1.5 wt % and in particular at least 2.5 wt % enzyme, at least 20 wt %, preferably at least 30 wt % and in particular at least 40 wt % of a softener and/or at least 1.5 wt %, preferably at least 3 wt %, especially preferably at least 4.5 wt % and in particular at least 10 wt % of at least one soil-repellent polymer, which preferably has terephthalate groups and sulfonate groups. If the detergent or treatment agent portion comprises an extra component, it preferably releases the active ingredient over 5 to 60 wash stages or treatment stages, preferably over 10 to 50 and in particular over 15 to 40 wash stages or treatment stages in an automatic washing machine. Preferably 1 g to 60 g, especially 1.5 g to 55 g and in particular 2 g to 50 g of the detergent or treatment agent portion containing the extra component is dissolved/dispersed per wash stage or treatment stage.

Another preferred subject matter of the present invention is a dimensionally stable one-piece detergent or treatment agent portion having a weight of at least 50 g, comprising an extra component for a detergent or treatment agent, preferably a bleach component, an enzyme and/or a finishing component for textiles and at least 6 wt % surfactant.

As already stated, the detergent or treatment agent portion preferably contains a basic detergent for white textiles and/or colored textiles, sensitive textiles and/or wool or an extra component for a detergent or treatment agent, preferably for a basic detergent for white textiles and/or colored textiles, sensitive textiles and/or wool, preferably a bleaching component, an enzyme component or a finishing component for textiles, antimicrobial active ingredients and/or nonionic surfactants, enzymes and mixtures of these components. Preferred components of the detergent or treatment agent portion include builders, nonionic surfactants, anionic surfactants, polymers, complexing agents, bleaching agents, bleach activators, bleach catalysts, enzymes, fragrances, dyes, pH adjusting agents, foam inhibitors, antiredeposition agents or soil-repellent polymers, graying inhibitors, softener components, phobizing agents or impregnation agents and antistatics, silicones, UV protectant substances and optical brighteners. These are described below.

The builders include in particular the zeolites, silicates, carbonates, organic cobuilders and, whenever there are no ecological prejudices against their use, also the phosphates.

Crystalline sheet silicates of the general formula NaMSiₓO₂ₓ₊₁.yH₂O are preferably used, where M denotes sodium or hydrogen, x is a number from 1.9 to 22, preferably from 1.9 to 4, especially preferred values for x being 2, 3 or 4, and y stands for a number from 0 to 33, preferably from 0 to 20. The crystalline sheet silicates of the formula NaMSiₓO₂ₓ₊₁.yH₂O are distributed by the company Clariant GmbH (Germany), for example, under the brand name Na-SKS. Examples of these silicates include Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O) or Na-SKS-4 (Na₂Si₄O₉.xH₂O, makatite).

For the purposes of the present invention, crystalline sheet silicates of the formula NaMSiₓO₂ₓ₊₁.yH₂O, in which x stands for 2 are especially preferred. In particular both β- and δ-sodium disilicates Na₂Si₂O₅.yH₂O as well as in particular Na-SKS-5 (α-Na₂Si₂O₄), Na-SKS-7 (β-Na₂Si₂O₅, natrosilite), Na-SKS-9 (NaHSi₂O₅.H₂O), Na-SKS-10 (NaHSi₂O₅.3H₂O, kanemite), Na-SKS-11 (t-Na₂Si₂O₅) and Na-SKS-13 (NaHSi₂O₅), but in particular also Na-SKS-6 (δ-Na₂Si₂O₅) are preferred.

Amorphous sodium silicates with a modulus of Na₂O:SiO₂ of 1:2 to 1:3.3, preferably from 1:2 to 1:2.8 and in particular from 1:2 to 1:2.6 may also be used, preferably having delayed dissolving and secondary washing properties. The delayed dissolving in comparison with traditional amorphous sodium silicates may be achieved in various ways, e.g., by surface treatment, compounding, compacting/compressing or by overdrying. Within the scope of this present invention, the term “amorphous” is understood to mean that the silicates do not form sharp x-ray reflexes in x-ray diffraction experiments such as those typical of crystalline substances but instead produce one or more maximums of the scattered x-ray radiation having a width of several degree units of the diffraction angle.

Alternatively or in combination with the aforementioned amorphous sodium silicates, silicates that are amorphous to x-rays are used, their silicate particles supply blurred or even sharp diffraction maximums in electron diffraction experiments. This is to be interpreted as meaning that the products have microcrystalline regions from 10 nm to a few hundred nm in size, with values up to max. 50 nm and in particular up to max. 20 nm being preferred. Such x-ray-amorphous silicates also have delayed dissolving in comparison with traditional water glasses. Compressed/compacted amorphous silicates, compounded amorphous silicates and overdried x-ray-amorphous silicates are preferred in particular.

Of course use of the phosphates which are known in general as builder substances is also possible if such a use should not be avoided for ecological reasons. Of the number of commercially available phosphates, the alkali metal phosphates have gained the greatest importance in the detergent and cleaning agent industry, with special preference for pentasodium triphosphate and/or pentapotassium triphosphate (sodium tripolyphosphate and/or potassium tripolyphosphate).

Alkali metal phosphate is the general term for the alkali metal salts (in particular sodium salts and potassium salts) of the various phosphoric acids, where a distinction can be made between metaphosphoric acids (HPO₃)ₙ and orthophosphoric acid H₃PO₄ in addition to higher molecular representatives. The phosphates combine several advantages: they act as alkali carriers, prevent calcium deposits on machine parts and/or calcium encrustations on fabrics and also contribute toward cleaning performance.

Phosphates that are especially important industrially include pentasodium triphosphate Na₅P₃O₁₀ (sodium tripolyphosphate) and the corresponding potassium salt, pentapotassium triphosphate K₅P₃O₁₀ (potassium tripolyphosphate). In addition, sodium potassium tripolyphosphates are preferred according to this invention.

Other builders include the alkali carriers. Alkali carriers are considered to be, for example, alkali metal hydroxides, alkali metal carbonates, alkali metal bicarbonates, alkali metal sesquicarbonates, the aforementioned alkali silicates, alkali metasilicates and mixtures of the aforementioned substances, whereby in the sense of this invention the alkali carbonates, in particular sodium carbonate, sodium bicarbonate or sodium sesquicarbonate are preferred for use. A builder system containing a mixture of tripolyphosphate and sodium carbonate is especially preferred. Likewise, especially preferred is a builder system containing a mixture of tripolyphosphate and sodium carbonate and sodium disilicate.

Especially preferred is the use of carbonate(s) and/or bicarbonate(s), preferably alkali carbonate(s).

Organic cobuilders include in particular polycarboxylates/polycarboxylic acids, polymeric polycarboxylates, aspartic acid, polyacetals, dextrins, other organic cobuilders (see below) and phosphonates. These classes of substances are described below.

Usable organic builder substances include, for example, the polycarboxylic acids that may be used in the form of the free acid and/or their sodium salts, where polycarboxylic acids are understood to be carboxylic acids having more than one acid function. For example, these are citric acid, adipic acid, succinic acid, glutaric acid, malic acid, tartaric acid, maleic acid, fumaric acid, sugar acids, aminocarboxylic acids, nitrilotriacetic acid (NTA) if such a use is not objectionable for ecological reasons, as well as mixtures thereof. The free acids typically also have the property of an acidifying component in addition to their builder effect and thus also serve to adjust a lower and milder pH of detergents or cleaning agents. In particular, citric acid, succinic acid, glutaric acid, adipic acid, gluconic acid and any mixtures thereof may be mentioned here.

Other suitable builders include polymeric polycarboxylates which include, for example, the alkali metal salts of polyacrylic acid or polymethacrylic acid, e.g., those having a relative molecular weight of 500 g/mol to 70,000 g/mol.

The molecular weights indicated for polymeric polycarboxylates in the sense of the present patent application are weight-average molecular weights M_{w} of the respective acid form, which have essentially been determined by gel permeation chromatography (GPC) using a UV detector. The measurement was performed against an external polyacrylic acid standard, which supplies realistic molecular weight values, because of its structural similarity to the polymers investigated. These values deviate significantly from the molecular weight values using polystyrenesulfonic acids as the standard. The molecular weights measured against polystyrenesulfonic acids are usually much higher than the molecular weights given in the present patent application.

Suitable polymers are in particular polyacrylates which preferably have a molecular weight of 2000 g/mol to 20,000 g/mol. Because of their superior solubility, the short-chain polyacrylates having molecular weights of 2000 g/mol to 10,000 g/mol and especially preferably from 3000 g/mol to 5000 g/mol may in turn be preferred.

Also suitable are copolymeric polycarboxylates, in particular those of acrylic acid with methacrylic acid and acrylic acid or methacrylic acid with maleic acid. Copolymers of acrylic acid with maleic acid containing 50 wt % to 90 wt % acrylic acid and 50 wt % to 10 wt % maleic acid have proven to be especially suitable. Their relative molecular weight, based on free acids, generally amounts to 2000 g/mol to 70,000 g/mol, preferably 20,000 g/mol to 50,000 g/mol and in particular 30,000 g/mol to 40,000 g/mol.

To improve water solubility, the polymers may also contain allylsulfonic acids, e.g., allyloxybenzenesulfonic acid and methallylsulfonic acid as monomers.

Biodegradable polymers of more than two different monomer units, e.g., those containing as monomers the salts of acrylic acid and maleic acid as well as vinyl alcohol and/or vinyl alcohol derivatives or containing as monomers the salts of acrylic acid and 2-alkylallylsulfonic acid as well as sugar derivatives are also preferred in particular.

Other preferred copolymers are those having as monomers acrolein and acrylic acid/acrylic acid salts and/or acrolein and vinyl acetate.

Likewise polymeric aminodicarboxylic acids, their salts or their precursor substances may also be mentioned as additional preferred builder substances. Especially preferred are polyaspartic acids and/or their salts.

Other suitable builder substances include polyacetals which can be obtained by reaction of dialdehydes with polyolcarboxylic acids having five to seven carbon atoms and at least three hydroxyl groups. Preferred polyacetals are obtained from dialdehydes such as glyoxal, glutaraldehyde, terephthalaldehyde and mixtures thereof and from polyol carboxylic acids such as gluconic acid and/or glucoheptonic acid.

Other suitable organic builder substances include dextrins, e.g., oligomers and/or polymers of carbohydrates that can be obtained by partial hydrolysis of starches. The hydrolysis may be performed by conventional methods, e.g., by acid-catalyzed or enzyme-catalyzed methods. These are preferably hydrolysis products with average molecular weights in the range of 400 g/mol to 500,000 g/mol. A polysaccharide with a dextrose equivalent (DE) in the range of 0.5 to 40, in particular from 2 to 30 is preferred, where DE is a conventional measure of the reducing effect of a polysaccharide in comparison with dextrose, which has a DE of 100. Both maltodextrins with a DE between 3 and 20 and dry glucose syrup with a DE between 20 and 37 as well as so-called yellow dextrins and white dextrins with higher molecular weights in the range of 2000 g/mol to 30,000 g/mol may also be used.

The oxidized derivatives of such dextrins are their reaction products with oxidizing agents which are capable of oxidizing at least one alcohol function of the saccharide ring to form the carboxylic acid function.

Oxydisuccinates and other derivatives of disuccinates, preferably ethylenediaminedisuccinate, are also suitable cobuilders. Ethylenediamine-N,N′-disuccinate (EDDS), preferably in the form of its sodium or magnesium salts is used. Glycerol disuccinates and glycerol trisuccinates are also preferred in this context.

Other usable organic cobuilders include, for example, acetylated hydroxycarboxylic acids and/or their salts, which may optionally also be in lactone form and which have at least four carbon atoms and at least one hydroxyl group plus at most two acid groups.

In addition, all compounds capable of forming complexes with alkaline earth ions may be used as builder substances.

The detergent or treatment agent portion preferably includes surfactants from the group of nonionic surfactants, anionic surfactants, amphoteric surfactants and/or zwitterionic surfactants, preferably nonionic and/or anionic surfactants. The detergent or treatment agent portion preferably contains at least 6 wt % surfactant, especially preferably at least 8 wt % surfactant, most especially preferably at least 10 wt % surfactant and in particular at least 12 wt % surfactant.

Nonionic surfactants that may be used include all the nonionic surfactants with which those skilled in the art are familiar. Preferred surfactants used are preferably low sudsing nonionic surfactants. Detergents or treatment agents especially preferably contain nonionic surfactants from the group of alkoxylated alcohols. The nonionic surfactants are preferably alkoxylated, advantageously ethoxylated, in particular primary alcohols with preferably 8 to 18 carbon atoms and an average of 1 to 12 mol ethylene oxide (EO) per mol alcohol, in which the alcohol radical may be linear or preferably branched in position 2 and/or may contain linear and methyl-branched radicals in mixture, such as those generally found in oxo alcohol radicals. However, alcohol ethoxylates with linear radicals from alcohols of native origin with 12 to 18 carbon atoms, e.g., from coconut, palm, tallow fat or oleyl alcohol and an average of 2 to 8 mol EO per mol alcohol are preferred in particular. The preferred ethoxylated alcohols include, for example, C₁₂₋₁₄ alcohols with 3 EO or 4 EO, C₉₋₁₁ alcohols with 7 EO, C₁₃₋₁₅ alcohols with 3 EO, 5 EO, 7 EO or 8 EO, C₁₂₋₁₈ alcohols with 3 EO, 5 EO or 7 EO and mixtures thereof such as mixtures of C₁₂₋₁₄ alcohol with 3 EO and C₁₂₋₁₈ alcohol with 5 EO. The stated degrees of ethoxylation are statistical averages which may correspond to an integer or a fraction for a specific product. Preferred alcohol ethoxylates have a narrow homolog distribution (narrow range ethoxylates, NRE). Alternatively or in addition to these nonionic surfactants, fatty alcohols with more than 12 EO may also be used. Examples include tallow fatty alcohol with 14 EO, 25 EO, 30 EO or 40 EO.

Furthermore, alkyl glycosides of the general formula RO(G)ₓ may also be used, where R corresponds to a primary, linear or methyl-branched aliphatic radical, preferably with methyl branching in position 2, having 8 to 22 carbon atoms, preferably 12 to 18 carbon atoms, and G is the symbol standing for a glycose unit with 5 or 6 carbon atoms, preferably glucose. The degree of oligomerization x which indicates the distribution of monoglycosides and oligoglycosides, may be any number between 1 and 10; x is preferably 1.2 to 1.4.

Another class of nonionic surfactants that are preferred for use and are used either as the sole nonionic surfactant or in combination with other nonionic surfactants include alkoxylated, preferably ethoxylated or propoxylated and ethoxylated fatty acid alkyl esters, preferably with 1 to 4 carbon atoms in the alkyl chain.

Nonionic surfactants of the amine oxide type, e.g., N-coconut alkyl-N,N-dimethylamine oxide and N-tallow alkyl-N,N-dihydroxyethylamine oxide and the fatty acid alkanolamides may also be suitable. The amount of these nonionic surfactants is preferably no more than the amount of the ethoxylated fatty alcohols, in particular no more than half of it.

Other suitable surfactants include polyhydroxy fatty acid amides of the formula

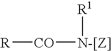

in which R stands for an aliphatic acyl radical with 6 to 22 carbon atoms, R¹ stands for hydrogen, an alkyl or hydroxyalkyl radical with 1 to 4 carbon atoms and [Z] stands for a linear or branched polyhydroxyalkyl radical with 3 to 10 carbon atoms and 3 to 10 hydroxyl groups. The polyhydroxy fatty acid amides are known substances which may generally be obtained by reductive amination of a reducing sugar with ammonia, an alkylamine or an alkanolamine and the subsequent acylation with a fatty acid, a fatty acid alkyl ester or a fatty acid chloride.

The group of polyhydroxy fatty acid amides also includes compounds of the formula

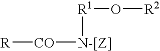

in which R stands for a linear or branched alkyl or alkenyl radical with 7 to 12 carbon atoms, R¹ stands for a linear, branched or cyclic alkyl radical or an aryl radical with 2 to 8 carbon atoms and R² stands for a linear, branched or cyclic alkyl radical or an aryl radical or an oxyalkyl radical with 1 to 8 carbon atoms, where C₁₋₄ alkyl or phenyl radicals are preferred and [Z] stands for a linear polyhydroxyalkyl radical whose alkyl chain is substituted with at least two hydroxyl groups, or alkoxylated, preferably ethoxylated or propoxylated derivatives of this radical.

[Z] is preferably obtained by reductive amination of a reduced sugar, e.g., glucose, fructose, maltose, lactose, galactose, mannose or xylose. The N-alkoxy- or N-aryloxy-substituted compounds can be converted to the desired polyhydroxy fatty acid amides by reaction with fatty acid methyl esters in the presence of an alkoxide as a catalyst.

In addition, combinations of one or more tallow fatty alcohols with 20 to 30 EO and silicone foam suppressants are also especially preferred.

Nonionics from the group of alkoxylated alcohols, especially preferably from the group of mixed alkoxylated alcohols and in particular from the group of EO/AO/EO nonionics or PO/AO/PO nonionics, specifically the PO/EO/PO nonionics are especially preferred. Such PO/EO/PO nonionics are characterized by good control of foaming.

Anionic surfactants used are, for example, those of the sulfonate and sulfate types. Surfactants of the sulfonate type include preferably C₉₋₁₃ alkylbenzenesulfonates, olefinsulfonates, i.e., mixtures of alkenesulfonates and -disulfonates and hydroxyalkanesulfonates and -disulfonates, such as those obtained from C₁₂₋₁₈ monoolefins, for example, and terminal or internal double bonds by sulfonation with gaseous sulfur trioxide and then alkaline or acidic hydrolysis of the sulfonation products. Alkanesulfonates obtained from C₁₂₋₁₈ alkanes, e.g., by sulfochlorination or sulfoxidation with subsequent hydrolysis and/or neutralization are also suitable. Likewise, the esters of α-sulfo fatty acids (ester sulfonates), e.g., the α-sulfonated methyl esters of hydrogenated coconut, palm kernel or tallow fatty acids, are also suitable.

Other suitable anionic surfactants are the sulfated fatty acid glycerol esters. Fatty acid glycerol esters are understood to be the monoesters, diesters and triesters as well as mixtures thereof, such as those obtained in production by esterification of a monoglycerol with 1 mol to 3 mol fatty acid or in transesterification of triglycerides with 0.3 mol to 2 mol glycerol. Preferred sulfated fatty acid glycerol esters are the sulfation products of saturated fatty acids having 6 to 22 carbon atoms, e.g., caproic acid, caprylic acid, capric acid, myristic acid, lauric acid, palmitic acid, stearic acid or behenic acid.

The preferred alk(en)yl sulfates are the alkali salts and in particular the sodium salts of sulfuric acid hemiesters of C₁₂-C₁₈ fatty alcohols, e.g., from coconut fatty alcohol, tallow fatty alcohol, lauryl, myristyl, cetyl or stearyl alcohol or the C₁₀-C₂₀ oxo alcohols and the hemiesters of secondary alcohols of these chain lengths. Also preferred are alk(en)yl sulfates of the aforementioned chain length having a synthetic linear alkyl radical synthesized on a petrochemical basis and having degradation properties similar to those of adequate compounds based on the raw materials of fat chemistry. The C₁₂-C₁₆ alkyl sulfates and C₁₂-C₁₅ alkyl sulfates and C₁₄-C₁₅ alkyl sulfates are preferred because of technical interest in washing. The 2,3-alkyl sulfates available as commercial products from Shell Oil Company under the brand name DAN® are also suitable anionic surfactants.

The sulfuric acid monoesters of the linear or branched C₇-C₂₁ alcohols ethoxylated with 1 to 6 mol ethylene oxide such as 2-methyl-branched C₉₋₁₁ alcohols with an average of 3.5 mol ethylene oxide (EO) or C₁₂₋₁₈ fatty alcohols with 1 to 4 EO are also suitable.

Other suitable anionic surfactants are also the salts of alkylsulfosuccinic acid, which are also referred to as sulfosuccinates or as sulfosuccinic acid esters, and the monoesters and diesters of sulfosuccinic acid with alcohols, preferably fatty alcohols and in particular ethoxylated fatty alcohols. Preferred sulfosuccinates contain C₈-C₁₈ fatty alcohol radicals or mixtures thereof. Especially preferred sulfosuccinates contain a fatty alcohol radical derived from ethoxylated fatty alcohols, which are nonionic surfactants when considered for themselves. In turn sulfosuccinates whose fatty alcohol radicals are derived from ethoxylated fatty alcohols with a narrow-range homolog distribution are especially preferred. It is likewise also possible to use alk(en)ylsuccinic acid with preferably 8 to 18 carbon atoms in the alk(en)yl chain or salts thereof.

Soaps in particular may be considered as additional anionic surfactants. Suitable soaps include saturated fatty acid soaps, e.g., the salts of lauric acid, myristic acid, palmitic acid, stearic acid, hydrogenated erucaic acid and behenic acid as well as in particular soap mixtures derived from natural fatty acids, e.g., coconut, palm kernel or tallow fatty acids.

The anionic surfactants including the soaps may be present in the form of their sodium, potassium or ammonium salts as well as soluble salts of organic bases such as monoethanolamine, diethanolamine or triethanolamine. The anionic surfactants are preferably in the form of their sodium or potassium salts, in particular in the form of their sodium salts.

The group of polymer include in particular the washing-active or treatment-active polymers and/or polymers that are active as softeners. In general, cationic, anionic and amphoteric polymers may also be used in addition to nonionic polymers in detergents or treatment agents.

“Cationic polymers” in the sense of the present invention are polymers having a positive charge in the polymer molecule. These may be implemented, for example, by (alkyl)ammonium groups present in the polymer chain or other positively charged groups. Especially preferred cationic polymers come from the groups of quaternary cellulose derivatives, polysiloxanes with quaternary groups, cationic guar derivatives, polymeric dimethyldiallylammonium salts and their copolymers with esters and amides of acrylic acid and methacrylic acid, the copolymers of vinylpyrrolidone with quaternated derivatives of dialkyl aminoacrylate and methacrylate, vinylpyrrolidone methoimidazolinium chloride copolymers, quaternated polyvinyl alcohols or the polymers known by the INCI designations polyquaternium 2, polyquaternium 17, polyquaternium 18 and polyquaternium 27.

“Amphoteric polymers” in the sense of the present invention also have, in addition to a positively charged group in the polymer chain, negatively charged groups and/or monomer units. These groups may be, for example, carboxylic acids, sulfonic acids or phosphonic acids.

The bleaching agents are an active washing or treatment substance used with special preference. Of the compounds used as bleaching agents which supply H₂O₂ in water, sodium percarbonate, sodium perborate tetrahydrate and sodium perborate monohydrate are especially important. Other bleaching agents that may be used include, for example, peroxypyrophosphates, citrate perhydrates and peracid salts or peracids that supply H₂O₂, e.g., perbenzoates, peroxophthalates, diperazelaic acid, phthaloimino peracid or diperdodecanedioic acid. In addition, bleaching agents from the group of organic bleaching agents may also be used. Typical organic bleaching agents include the diacyl peroxides, e.g., dibenzoyl peroxide. Other typical organic bleaching agents are the peroxy acids, examples of which that may be mentioned include in particular the alkylperoxy acids and arylperoxy acids. Preferred representative include (a) the peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids such as peroxylauric acid, peroxystearic acid, ε-phthalimidoperoxycaproxic acid (phthaliminoperoxyhexanoic acid (PAP)), o-carboxybenzamidoperoxycaproic acid, N-nonenylamidoperadipic acid and N-nonenylamidopersuccinate and (c) aliphatic and araliphatic peroxydicarboxylic acids such as 1,12-diperoxycarboxylic acid, 1,9-diperoxyazelaic acid, diperoxysebacic acid, diperoxybrassylic acid, diperoxyphthalic acids, 2-dicyldiperoxybutane-1,4-dioic acid, N,N-terephthaloyldi(6-aminopercaproic acid).

Substances that release chlorine or bromine may also be used as bleaching agents. Of the suitable materials that release chlorine or bromine, for example, heterocyclic N-bromoamide and N-chloroamides, e.g., trichloroisocyanuric acid, tribromoisocyanuric acid, dibromoisocyanuric acid and/or dichloroisocyanuric acid (DICA) and/or the salts with cations such as potassium and sodium may also be considered. Hydantoin compounds, e.g., 1,3-dichloro-5,5-dimethylhyantoin are also suitable.

Bleach activators are used in detergents or treatment agents, for example, to achieve an improved bleaching effect at temperature of 60° C. and lower. Bleach activators that may be used include compounds that yield aliphatic peroxycarboxylic acids with preferably 1 to 10 carbon atoms, in particular 2 to 4 carbon atoms and/or optionally substituted perbenzoic acid under perhydrolysis conditions. Substances that carry O- and/or N-acyl groups of the aforementioned number of carbon atoms and/or optionally substituted benzoyl groups are also suitable. Preferred are the polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenol sulfonates, in particular n-nonanoyl- or isononanoyloxybenzenesulfonate (n- and/or iso-NOBS), carboxylic acid anhydrides, in particular phthalic acid anhydride, acylated polyvalent alcohols, in particular triacetin, ethylene glycol diacetate and 2,5-diacetoxy-2,5-dihydrofuran, n-methylmorpholinium-acetonitrile-methyl sulfate (MMA) and acylated sorbital and mannitol and mixtures thereof (SORMAN), acylated sugar derivatives, in particular pentaacetylglucose (PAG), pentaacetylfructose, tetraacetylxylose and octaacetyllactose as well as acetylated optionally N-alkylated glucamine and gluconolactone and/or N-acylated lactams, e.g., N-benzoylcaprolactam. Acylacetals and acyllactams with hydrophilic substituents are also preferred for use. Combinations of conventional bleach activators may also be used.

Additional bleach activators preferred for use within the scope of the present invention are compounds from the group of cationic nitriles, in particular cationic nitriles of the formula

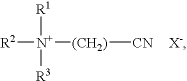

in which R¹ stands for H, CH₃, a C₂₋₂₄ alkyl radical or alkenyl radical, a substituted C₂₋₂₄ alkyl or alkenyl radical having at least one substituent from the group of Cl, Br, OH, NH₂, CN, an alkyl or alkenylaryl radical with a C₁₋₂₄ alkyl group or a substituted alkyl or alkenylaryl radical with a C₁₋₂₄ alkyl group and at least one additional substituent on the aromatic ring, R² and R³ independently of one another are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH, where n=1, 2, 3, 4, 5 or 6 and X is an anion, preferably from the group of chloride, bromide, iodide, bisulfate, methosulfate, p-toluenesulfonate (tosylate) or xylenesulfonate.

Especially preferred are the compounds of the formulas (CH₃)₃N⁽⁺⁾CH₂—CHX⁻, (CH₃CH₂)₃N⁽⁺⁾CH₂—CNX⁻, (CH₃CH₂CH₂)₃N⁽⁺⁾CH₂—CNX⁻, (CH₃CH(CH₃))₃N⁽⁺⁾CH₂—CNX⁻ or (HO—CH₂—CH₂)₃N⁽⁺⁾CH₂—CNX⁻, wherein from the group of these substances, the cationic nitrile of the formula (CH₃)₃N⁽⁺⁾CH₂—CNX⁻, in which X⁻ stands for an anion selected from the group of chloride, bromide, iodide, bisulfate, methosulfate, p-toluenesulfonate (tosylate) or xylenesulfonate, are in turn especially preferred.

In addition to or instead of the conventional bleach activators, so-called bleach catalysts may also be used. These substances are typically bleach-enhancing transition metal salts and/or transition metal complexes, such as Mn-, Fe-, Co-, Ru- or Mo-salene complexes or -carbonyl complexes. Mn, Fe, Co, Ru, Mo, Ti, V and Cu complexes with N-containing tripod ligands as well as Co-, Fe-, Cu- and Ru-ammine complexes may also be used as bleach catalysts.

Bleach-enhancing transition metal complexes, in particular with the central atoms Mn, Fe, Co, Cu, Mo, V, Ti and/or Ru, preferably selected from the group of manganese and/or cobalt salts and/or complexes, especially preferably the cobalt-(ammine) complexes, the cobalt-(acetate) complexes, the cobalt-(carbonyl) complexes, the chlorides of cobalt or manganese, manganese sulfate, are used in the conventional amounts.

Complexes of manganese in oxidation states II, III, IV or IV are especially preferred, preferably containing one or more macrocyclic ligand(s) with the donor function N, NR, PR, O and/or S. Ligands having nitrogen donor functions are preferred. It is especially preferable to use bleach catalyst(s) in the inventive agents which contain as macromolecular ligands 1,4,7-trimethyl-1,4,7-triazacyclonanone (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me/TACN). Suitable manganese complexes include, for example:

[Mn^{III}₂(μ-O)₁(μ-OAc)₂(TACN)₂](ClO₄)₂,

[Mn^{III}Mn^{IV}(μ-O)₁(μ-OAc)₂(TACN)₂](BPh₄)₂,

[Mn^{IV}₄(μ-O)₆(TACN)₄](ClO₄)₄,

[Mn^{III}₂(μ-O)₁(μ-OAc)₂(Me-TACN)₂](ClO₄)₂,

[Mn^{III}Mn^{IV}(μ-O)₁(μ-OAc)₂(Me-TACN)₂](ClO₄)₃,

[Mn^{IV}₂(μ-O)₃(Me-TACN)₂](PF₆)₂ and

[Mn^{IV}₂(μ-O)₃(Me/Me-TACN)₂](PF₆)₂(OAc=OC(O)CH₃).

Enzymes may be used to increase the detergency/washing power of detergents or treatment agents. These include in particular proteases, amylases, lipases, hemicellulases, cellulases or oxidoreductases and preferably the mixtures thereof. These enzymes are in principle of natural origin; starting from the natural molecules, improved variants are available for use in detergents or treatment agents and/or preferred for use accordingly.

Of the proteases, those of the subtilisin type are preferred. Examples include the subtilisins BPN′ and Carlsberg as well as their more developed forms, protease PB92, subtilisins 147 and 309, the alkaline protease from Bacillus lentus, subtilisin DY and the enzymes thermitase, proteinase K and proteases TW3 and TW7 which are classified as subtilases but are no longer classified as subtilisins in the narrower sense.

Examples of amylases that may be used include the α-amylases from Bacillus licheniformis, from B. amyloliquefaciens, from B. stearothermophilus, from Aspergillus niger and from A. oryzae as well as the further developments of the aforementioned amylases that have been improved for use in detergents or cleaning agents. In addition, the α-amylase from Bacillus sp. A 7-7 (DSM 12368) and the cyclodextrin glucanotransferase (CGTase) from B. agaradherens (DSM 9948) are to be emphasized for this purpose.

Lipases or cutinases may also be used, in particular because of their triglyceride-cleaving activities but also to be able to produce peracids in situ from suitable precursors. These include, for example, the lipases obtainable originally from Humicola lanuginosa (Thermomyces lanuginosus) and/or developed further, in particular those with the amino acid exchange D96L. In addition, for example, the cutinases originally isolated from Fusarium solai pisi and Humicola insolens may also be used. Furthermore, lipases and/or cutinases whose starting enzymes were originally isolated from Pseudomonas mendocina and Fusarium solanii may also be used.

Enzymes combined under the term “hemicellulases” may also be used. These include, for example, mannases, xanthan lyases, pectin lyases (=pectinases), pectin esterases, pectate lyases, xyloglucanases (=xylanases), pullulanases and β-glucanases.

Perhydrolases are especially preferably used in the inventive agents.

To increase the bleaching effect, oxidoreductases, e.g., oxidases, oxygenases, catalases, peroxidases such as halo-, chloro-, bromo-, lignin, glucose or manganese peroxidases, dioxygenases or laccases (phenol oxidases, polyphenol oxidases) may also be used. Advantageously, organic preferably aromatic compounds that interact with the enzymes are additionally added to enhance the activity of the respective oxidoreductases (enhancers) or to ensure electron flow at the very different redox potentials between the oxidizing enzymes and the soiling (mediators).

The enzymes may be used in any established form according to the state of the art. These include, for example, the solid preparations obtained by granulation, extrusion or lyophilization or, in particular in the case of liquid or gelatinous agents, solutions of the enzymes, advantageously in the most concentrated form possible, with a low water content and/or mixed with stabilizers.

As an alternative, the enzymes may also be encapsulated for the solid dosage form as well as for the liquid dosage form, e.g., by spray drying or extrusion of the enzyme solution together with a preferably natural polymer or in the form of capsules, e.g., those in which the enzymes are enclosed as in a solidified gel or in those of the core-shell type, in which a core containing an enzyme is coated with a protective layer that is impermeable to water, air and/or chemicals. In additional layers, other active ingredients, e.g., stabilizers, emulsifiers, pigments, bleaching agents or dyes may also be applied. Such capsules are applied by essentially known methods, e.g., by shaking granulation or rolling granulation or in fluidized bed processes. Such granules advantageously have a low dust production, e.g., due to the application of polymeric film-forming agents, and are stable in storage due to the coating.

In addition, it is possible to fabricate two or more enzymes together, so that a single granular product contains multiple enzyme activities.

A protein and/or enzyme may be protected especially during storage against damage, e.g., due to inactivation, denaturing or disintegration, e.g., due to physical influences, oxidation or proteolytic cleavage. In the case of microbial production of proteins and/or enzymes, inhibition of proteolysis is especially preferred, in particular when the agents also contain proteases. Detergents or treatment agents may contain stabilizers for this purpose.

The perfume oils and/or fragrances used within the scope of the present invention include individual perfume compounds, e.g., synthetic products of the type of esters, ethers, aldehydes, ketones, alcohols and hydrocarbons. However, mixtures of different scents which together produce an appealing fragrance note are preferred. Such perfume oils may also contain natural fragrance mixtures, such as those accessible from plant sources, e.g., pine oil, citrus oil, jasmine oil, patchouli oil, rose oil or ylang ylang oil.

To be perceptible, a fragrance must be volatile, where the molecular weight also plays an important role in addition to the nature of the functional groups and the structure of the chemical compound. For example, most fragrances have molecular weights up to approx. 200 dalton, but molecular weights of 300 dalton and more are more likely an exception. On the basis of the differing volatility of fragrances, the scent of a perfume and/or fragrance comprising multiple fragrance ingredients changes during evaporation, so the scent impressions are subdivided according to “top notes,” “middle notes” and/or “body” and “end notes” and/or “dry out.” The scent perception is based mostly on the intensity of a scent, so the top note of a perfume and/or fragrance does not consist exclusively of volatile compounds, while the end note consists mostly of less volatile, i.e., adherent perfumes. In the composition of perfumes, more volatile fragrances may be bound to certain fixatives, so that they are prevented from evaporating too rapidly. In the subsequent classification of fragrances into “more volatile” and/or “adherent” perfumes, nothing is said about the scent impression or about whether the corresponding fragrance is perceived as a top note or as a middle note.

The fragrances can be processed directly but it may also be advantageous to the apply the fragrances to carriers, which ensure a more gradual release of the fragrance for a long-lasting scent. Such carrier materials have proven to be, for example, cyclodextrins, where the cyclodextrin-perfume complexes may additionally also be coated with other additives.

In the choice of the coloring agent, it is necessary to consider that the coloring agents have a good stability in storage and are insensitive to light and do not have an extremely high affinity for textile surfaces, in particular plastic fibers here. At the same time, also to be considered in the choice of suitable coloring agents is that coloring agents have different stabilities with respect to oxidation. It is true in general that water-insoluble coloring agents are more stable than water-soluble coloring agents with respect to oxidation. The concentration of the coloring agent in the detergents or treatment agents varies depending on the solubility and thus also the oxidation sensitivity. In the case of readily water-soluble coloring agents, coloring agent concentrations in the range of a few 10⁻² to 10⁻³ wt % are typically selected. With the pigment dyes, which are especially preferred because of their brilliance but are less water-soluble, the suitable concentration of the coloring agent in the detergents or treatment agents is typically a few 10⁻³ to 10⁻⁴ wt %.

Coloring agents which can be destroyed by oxidation in the washing process and mixtures thereof with suitable blue dyes, so-called blue toners, are preferred. It has proven advantageous to use coloring agents which are soluble in water or are soluble at room temperature in liquid organic substances. For example, anionic coloring agents, e.g., anionic nitroso dyes are suitable.

To bring the pH of detergents of treatment agents to the desired range, the use of pH regulating agents may be indicated. All known acids and/or bases may be used here if their use is not prohibited for technical reasons pertaining to the applications or for ecological reasons or for reasons of consumer protection. The amount of these regulating agents usually does not exceed 1 wt % of the total formulation.

Foam inhibitors include, for example, soaps, oils, fats, paraffins or silicone oils, which may optionally be applied to carrier materials. Suitable carrier materials include, for example, inorganic salts such as carbonate or sulfates, cellulose derivatives of silicates and mixtures of the aforementioned materials. Within the scope of the present invention, preferred agents contain paraffins, preferably unbranched paraffins (n-paraffins) and/or silicones preferably linear polymer silicones which are constructed according to the scheme (R₂SiO)ₓ and are also referred to as silicone oils. These silicone oils are usually clear, colorless, neutral, odorless, hydrophobic liquids having a molecular weight between 1000 and 150,000 and viscosities between 10 mPa·s and 1,000,000 mPa·s.

Suitable antiredeposition agents, also referred to as soil repellants, include, for example, nonionic cellulose ethers such as methylcellulose and methylhydroxypropylcellulose with a methoxy group content of 15 wt % to 30 wt % and a hydroxypropyl group content of 1 wt % to 15 wt %, each based on the nonionic cellulose ether and the polymers of phthalic acid and/or terephthalic acid known from the state of the art and/or their derivatives, in particular polymers of ethylene terephthalates and/or polyethylene glycol terephthalates or anionically and/or nonionically modified derivatives thereof. In particular, of these, the sulfonated derivatives of phthalic acid polymers and terephthalic acid polymers are especially preferred.

Graying inhibitors have the task of keeping the soil released from the fiber suspended in the water and preventing reuptake of the soil. Water-soluble colloids, usually of an organic nature, are suitable for this purpose, e.g., the water-soluble salts of polymeric carboxylic acids, glue, gelatin, salts of ether sulfonic acids of starch or of cellulose or salts of acidic sulfuric acid esters of cellulose or of starch. Water-soluble polyamides containing acid groups are also suitable for this purpose. In addition, soluble starch preparations and starch products other than those mentioned above may also be used, e.g., degraded starch, aldehyde starches, etc. Polyvinylpyrrolidone may also be used. Cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethylcellulose and mixtures thereof may also be used as graying inhibitors.

Synthetic antiwrinkle agents may also be used, because textile fabrics, in particular of rayon, cellulose, cotton and blends thereof may tend to wrinkle because the individual fibers are sensitive to bending, folding, pressing and squeezing across the fiber direction. These include, for example, synthetic products based on fatty acids, fatty acid esters, fatty acid amides, alkylol esters, alkylolamides or fatty alcohols, which are usually reacted with ethylene oxide, or products based on lecithin or modified phosphoric acid esters.

To combat microorganisms, antimicrobial active ingredients may also be used in the part of a detergent or treatment agent portion that is not provided for care of the automatic washing machine. A distinction is made here between bacteriostatics and bactericides, fungistatics and fungicides, etc., according to the antimicrobial spectrum and mechanism of action. Suitable antimicrobial active ingredients are preferably selected from the groups of alcohols, amines, aldehydes, antimicrobial acids and/or their salts, carboxylic acid esters, acid amides, phenols, phenol derivatives, diphenyls, diphenylalkanes, urea derivatives, oxygen and nitrogen acetals and formals, benzamidines, isothiazolines, phthalimide derivatives, pyridine derivatives, antimicrobial surfactant compounds, guanidines, antimicrobial amphoteric compounds, quinolines, 1,2-dibromo-2,4-dicyanobutane, iodo-2-propynylbutyl carbamate, iodine, iodophores, peroxy compounds, halogen compounds and any mixtures of the above.

In a preferred embodiment, the antimicrobial active ingredient is selected from ethanol, n-propanol, isopropanol, 1,3-butanediol, phenoxyethanol, 1,2-propylene glycol, glycerol, undecylenic acid, benzoic acid, salicylic acid, dihydracetic acid, o-phenylphenol, N-methylmorpholinium acetonitrile (MMA), 2-benzyl-4-chlorophenol, 2,2′-methylene-bis(6-bromo-4-chlorophenol), 4,4′-dichloro-2′-hydroxydiphenyl ether (d ichlosan), 2,4,4′-trichloro-2′-hydroxydiphenyl ether (trichlosan), chlorhexidine, N-(4-chlorphenyl)-N-(3,4-dichlorophenyl)urea, N,N′-(1,10-decanediyldi-1-pyridinyl-4-ylidene)bis(1-octanamine) dihydrochloride, N,N′-bis-(4-chlorophenyl)-3,12-diimino-2,4,11,13-tetraazatetradecanediimideamide, glucoprotamines, antimicrobial surfactant quaternary compounds, guanidines including the biguanidines and polyguanidines, halogenated xylene and cresol derivatives such as p-chlorometacresol or p-chlorometaxylene, amphoterics and natural antimicrobial active ingredients of plant origin (e.g., from spices or herbs) of animal and microbial origin, especially preferably at least one quaternary antimicrobial surfactant compound, a natural antimicrobial active ingredient of plant origin and/or a natural antimicrobial active ingredient of animal origin, extremely preferably at least one natural antimicrobial active ingredient of plant origin from the group comprising caffeine, theobromine and theophyllines as well as essential oils such as eugenol, thymol and geraniol and/or at least one natural antimicrobial active ingredient of animal origin from the group comprising enzymes such as protein from milk, lysozyme and lactoperoxidase and/or at least one quaternary antimicrobial surfactant compound having an ammonium, sulfonium, phosphonium, iodonium or arsonium group, peroxo compounds and chlorine compounds. Substances of microbial origin, so-called bacteriocines, may also be used.

Quaternary ammonium compounds (quats) suitable as antimicrobial active ingredients have the general formula (R¹)(R²)(R³)(R⁴)N⁺X⁻ in which R¹ to R⁴ denote the same or different C₁-C₂₂ alkyl radicals, C₇-C₂₈ aralkyl radicals or heterocyclic radicals, whereby two radicals or, in the case of an aromatic bond as in pyridine, even three radicals together with the nitrogen atom form the heterocycle, e.g., a pyridinium compound or an imidazolinium compound, and X⁻ denotes halide ions, sulfate ions, hydroxide ions or similar anions. For an optimal antimicrobial action, preferably at least one of the radicals has a chain length of 8 to 18 carbon atoms, in particular 12 to 16 carbon atoms.

Quats can be synthesized by reaction of tertiary amines with alkylating agents, methyl chloride, benzyl chloride, dimethyl sulfate, dodecyl bromide as well as ethylene oxide. Alkylation of tertiary amines with a long alkyl radical and two methyl groups is accomplished especially easily, and quaternation of tertiary amines with two long radicals and one methyl group may also be performed under mild conditions with the help of methyl chloride. Amines which have three long alkyl radicals or hydroxy-substituted alkyl radicals are less reactive and are preferably quaternated with dimethyl sulfate.

Suitable quats include, for example, benzalkonium chloride (N-alkyl-N,N-dimethylbenzylammonium chloride, CAS no. 8001-54-5), benzalkon B (m,p-dichlorobenzyldimethyl-C₁₋₂-alkylammonium chloride, CAS no. 58390-78-6), benzoxonium chloride (benzyldodecyl-bis-(2-hydroxyethyl)ammonium chloride), cetrimonium bromide (N-hexadecyl-N,N-trimethylammonium bromide, CAS no. 57-09-9), benzethonium chloride (N,N-dimethyl-N-[2-[2-[p-(1,1,3,3-tetramethylbutyl)phenoxy]ethoxy]ethyl]benzylammonium chloride, CAS no. 121-54-0), dialkyldimethylammonium chlorides, such as di-n-decyldimethylammonium chloride (CAS no. 7173-51-5-5), didecyldimethylammonium bromide (CAS no. 290-68-3), dioctyidimethylammonium chloride, 1-cetylpyridinium chloride (CAS no. 123-03-5) and thiazoline iodide (CAS no. 15764-48-1) as well as mixtures thereof. Especially preferred quats are benzalkonium chlorides having C₈-C₁₈ alkyl radicals, in particular C₁₂-C₁₄ alkylbenzyldimethylammonium chloride.

Suitable antimicrobial active ingredients also include bleach compounds. These were already described previously.

In an especially preferred embodiment, the detergents or cleaning agent portion comprises a machine care agent. The machine care agent preferably comprises care components and/or antimicrobial active ingredients. The term “antimicrobial active ingredient” is understood to refer to those substances, e.g., bactericides and fungicides, which kill microorganisms, but also those substances, e.g., bacteriostatics and fungistatics, which only inhibit multiplication of the microorganisms. The machine care agent especially preferably contains a combination of at least one care component and at least one antimicrobial compound.

“Care component” in the sense of the present invention means that this component has water softening and/or lime dissolving properties and/or protects metal, e.g., stainless steel and/or rubber, e.g., seals and tubing. These include, for example, solvents such as isopropanol or ethanol to eliminate fat-based soiling, nonionic or anionic surfactants that have already been listed, complexing agents such as thiourea and sodium thiosulfate as well as silicone compounds and fine polishing particles as well as components with which those skilled in the art are familiar under the term “silver corrosion inhibitors.”

Suitable water softeners include all substances known in the state of the art capable of complexing Ca ions. Descalers are substances capable of dissolving lime scale and preferably also keeping it in solution.

To prevent unwanted changes in the detergents or treatment agents and/or the textiles treated with them, where such changes are due to the action of oxygen and other oxidative processes, these agents may also contain antioxidants. This class of compounds includes, for example, substituted phenols, hydroquinones, pyrocatechols and aromatic amines as well as organic sulfides, polysulfides, dithiocarbamates, phosphites and phosphonates.

In addition, UV protectants, which are absorbed on the treated textiles and improve the lightfastness of the fibers may also be used. Compounds having these desired properties include, for example, the compounds and derivatives of benzophenone with substituents in position 2 and/or 4 that are active due to radiationless deactivation. In addition, substituted benzotriazoles, acrylates with phenol substituents in position 3 (cinnamic acid derivatives), optionally with cyano groups in position 2, salicylates, organic Ni complexes as well as natural substances such as umbelliferone and the endogenous urocanic acid are also suitable.

Cationic active ingredients that may be used include, for example, cationic compounds of the following formulas:

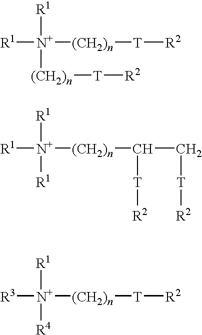

in which each R¹ group independently of the others is selected from C₁₋₆ alkyl, alkenyl or hydroxyalkyl groups; each R² group independently of the others is selected from C₈₋₂₈ alkyl or alkenyl groups; R³═R¹ or (CH₂)ₙ-T-R²; R⁴═R¹ or R² or (CH₂)ₙ-T-R²; T=CH₂, O—CO or CO—O and n is an integer from 0 to 5.

Fabric softener compounds may be used to care for the textiles and to improve the textile properties such as a softer “feel” (finish) and reduced electrostatic charge buildup (increased wearing comfort). The active ingredients of these formulations are quaternary ammonium compounds having two hydrophobic radicals such as distearyldimethylammonium chloride, but because of its inadequate biodegradability, this has increasingly been replaced by quaternary ammonium compounds containing in their hydrophobic radicals ester groups as the intended breaking points for biodegradation. Such “ester quats” having an improved biodegradability are obtainable, for example, by esterifying mixtures of methyldiethanolamine and/or triethanolamine with fatty acids and then quaternating the reaction products with alkylating agents in an essentially known manner. Dimethylolethylene urea is also suitable as a finish.

Phobizing and impregnating methods are used to finish textiles with substances that prevent deposition of soil or facilitate the ability to wash out soiling. Preferred phobizing and impregnating agents include perfluorinated fatty acids, also in the form of their aluminum and zirconium salts, organic silicates, silicones, polyacrylic acid esters with a perfluorinated alcohol component or polymerizable compounds coupled to a perfluorinated acyl or sulfonyl radical. Penetration of the impregnating agents in the form of solutions or emulsions of the respective active ingredients can be facilitated by adding wetting agents which reduce the surface tension. Another area for use of phobizing and impregnating agents is water-repellant finishing of textile goods in which, in contrast with waterproofing, the pores of the fabric are not closed so the substance retains an active breathability (hydrophobizing). The hydrophobizing agents used for hydrophobizing cover the textiles with a very thin layer of hydrophobic groups such as longer alkyl chains or siloxane groups. Suitable hydrophobizing agents include, for example, paraffins, waxes, metal soaps, etc. with the addition of aluminum salts or zirconium salts, quaternary ammonium compounds with long-chain alkyl radicals, urea derivatives, fatty acid-modified melamine resins, chromium complex salts, silicones organotin compounds and glutardialdehyde as well as perfluorinated compounds. The hydrophobized materials do not feel greasy but nevertheless droplets of water bead up on them as on oiled substances without wetting them. For example, silicone-impregnated textiles have a soft feel and are water repellent and dirt repellent; spots of ink, wine, fruit juice and the like are easier to remove.

Increased wearing comfort may result from the additional use of antistatics. Antistatics increase the surface conductivity and thus allow improved dissipation of charges that are formed. External antistatics are usually substances with at least one hydrophilic molecular ligand and form a more or less hygroscopic film on the surface. These antistatics, which are usually also surfactants, can be subdivided into antistatics that contain nitrogen (amines, amides, quaternary ammonium compounds), antistatics that contain phosphorus (phosphoric acid esters) and antistatics that contain sulfur (alkylsulfonates, alkyl sulfates). Lauryl (and/or stearyl) dimethylbenzylammonium chlorides are also suitable antistatics for textiles and/or as additives to detergents or treatment agents with which a finish effect is also to be achieved.

To improve the water absorbency, the rewettability of the treated textiles and to facilitate ironing of the treated textiles, silicone derivatives may be used. They additionally improve the rinsing performance of detergents or treatment agents due to their foam inhibiting properties. Preferred silicone derivatives include, for example, polydialkyl- or alkylarylsiloxanes in which the alkyl groups have one to five carbon atoms and are entirely or partially fluorinated. Preferred silicones include polydimethylsiloxanes, optionally derivatized and then quaternated or amino-functional and/or having Si—OH, Si—H and/or Si—Cl bonds. Other preferred silicones are the polyalkylene oxide-modified polysiloxanes, i.e., polysiloxanes having polyethylene glycols, for example, as well as polyalkylene oxide-modified dimethylpolysiloxanes.

Finally, UV protectants may also be used, which are absorbed on the treated textiles and improve the lightfastness of the fibers, may also be used. Compounds having these desired properties include, for example, the compounds and derivatives of benzophenone with substituents in positions 2 and/or 4 that are active due to radiationless deactivation. Also suitable are the substituted benzotriazoles, acrylates with phenol substituents in position 3 (cinnamic acid derivatives), optionally with cyano groups in position 2, salicylates, organic Ni complexes as well as natural substances such as umbelliferone and the endogenous urocanic acid.

Optical brighteners (so-called “whiteners”) may be added to the detergents or cleaning agents to eliminate graying and yellowing of the treated textiles. These substances are absorbed on the fiber and have a lightening effect and a simulated bleaching effect by converting invisible ultraviolet radiation into visible light of a longer wavelength, such that the ultraviolet light absorbed from sunlight is emitted as faintly bluish fluorescence and yields pure white when combined with the yellow tone of grayed and/or yellowed laundry. Suitable compounds originate, for example, from the substance classes of 4,4′-diamino-2,2′-stilbenedisulfonic acids (flavonic acids), 4,4′-distyrylbiphenylene, methylumbelliferones, coumarins, dihydroquinolinones, 1,3-diarylpyrazoline, naphthalic acid imides, benzoxazole, benzisoxazole and benzimidazole systems as well as the pyrene derivatives substituted by heterocycles.

The detergent or treatment agent preferably has a core containing an active ingredient having a composition different from that of the remaining detergent or treatment agent portion.

For simplification, in the presence of a core in the inventive detergent or treatment agent portion, the parts of the inventive detergent or treatment agent portion which are not core are referred to as “coating layer(s) containing active ingredient” or “layer(s) containing active ingredient.”

The core preferably also contains a machine care agent, preferably comprising a combination of at least one care component and at least one antimicrobial component.

For example, microbial contamination in the automatic washing machine can be counteracted and/or the interior of the automatic washing cared for by the fact that after a number (n) of wash stages or treatment stages, a disinfectant/care substance is released in another (n+₁)^{th} wash stage or treatment stage. This is achieved by an especially preferred embodiment of the present invention in which the detergent or treatment agent portion contains a core having an active ingredient, including a machine care agent, which comes in contact with the environment only after the coating layer containing the active ingredient has been dissolved/dispersed. It may be preferable for the core to also contain additional active washing or treatment substances besides the machine care agent, so that even in the last wash stage or treatment stage, textiles can still be washed and/or treated with the inventive detergent or treatment agent portion in which the machine care agent is released.

Alternatively or in combination, the machine care agent may also be contained in a detergent or treatment agent phase present outside of that according to the invention and in this way released before dissolving/dispersion of the detergent or treatment agent. In this way, the automatic washing machine is cared for/disinfected in the first wash stage or treatment stage which is performed with the inventive detergent or treatment agent portion. The detergent or treatment agent for the textiles is preferably released only in the wash stages or treatment stages following this first wash stage or treatment stage. However, it is also possible to provide for the coating layer that contains the active ingredient to also contain a detergent or treatment agent and additionally to contain a machine care agent, so that textiles can be washed and/or treated even in the first wash stage or treatment stage in which the inventive detergent or treatment agent portion is used.

The core containing the active ingredient of the detergent or treatment agent portion preferably includes a machine care agent which does not come in contact with the environment until after dissolving/dispersion of the coating layer containing the active ingredient and which preferably contains water softening substances and/or stainless steel care agents and/or care substances for elastic parts and/or active ingredients from the group of substances that kill microorganisms or inhibit their reproduction. Suitable care components and antimicrobial components have already been discussed briefly.

In another preferred embodiment of the inventive detergent or treatment agent portion, it comprises multiple layers containing active ingredient.

In one embodiment having multiple layers containing active ingredient, the inventive detergent or treatment agent portion has at least two layers, preferably between three and twenty layers and in particular four to fifteen layers which are dissolved/dispersed during use in an automatic washing machine essentially one after the other from the outside to the inside. It is especially preferable if at most one layer, preferably one of the layers of the detergent or treatment agent is consumed per wash stage or treatment stage.

The layers especially preferably have essentially the same composition. If one layer of the portion is always dissolved/dispersed in multiple wash stages or treatment stages, then preferably the same active ingredients are always released in the same quantity ratios and preferably in a comparable amount.

However, it is also possible to provide for the individual layers to differ in composition. For example, it is preferable for the layers to have different colors, so that the consumer can track the layer structure on the basis of the color change in the detergent or treatment agent portion. Fabrication of the individual layers with different fragrances is also preferred; this has the effect that textiles washed or treated in separate wash stages or treatment stages have different scents.

It is also possible for one detergent or treatment agent portion to have two or more different “types of layers” which are arranged in alternation. For example, the first layer may contain a basic detergent for white textiles and/or colored textiles, sensitive textiles and/or wool which is to be dissolved and/or dispersed in the wash cycle or treatment cycle (in heated water) and the second layer comprises a finishing component for textiles which is to be released only in the rinse cycles. The solubility/dispersibility of layers that are to be dissolved and/or dispersed mainly in the rinse cycles is preferably controlled through the pH and/or the ionic strength of the solution in use by means of a (physico)chemical switch, so that the corresponding layer dissolves/disperses during the cycles in which there is little or no detergent or treatment agent dissolved in the water, i.e., in the rinse cycles, but does not dissolve/disperse at all or does so only to a slight extent in the cycles during which detergent or treatment agent is dissolved in the water in a significant amount.

The (physico)chemical switch may contain one or more substances from the group comprising (acidic) cellulose derivatives, in particular cellulose acetate phthalate, hydroxypropylmethylcellulose phthalate, hydroxypropylmethylcellulose acetate succinate, methylcellulose, hydroxymethylcellulose, hydroxypropylcellulose, methylhydroxyethylcellulose, carboxymethylcellulose with different degrees of substitution, (acidic) poly(meth)acrylates, in particular methacrylic acid-methacrylate copolymer, methacrylic acid-ethyl acrylate copolymer, (acidic) polymers based on vinyl alcohol, in particular polyvinyl acetate phthalate, polyvinylpyrrolidones, polystyrene sulfonate, shellac, proteins, basic polymers and/or copolymers, in particular basic polymers and/or copolymers containing amino groups amino groups and/or aminoalkyl groups, imino groups and/or pyridine groups, and in particular aminoalkyl methacrylate copolymer. The switch especially preferably comprises cellulose derivatives, in particular methylcellulose, hydroxyethylcellulose, hydroxypropylcellulose, methylhydroxyethylcellulose, carboxymethylcellulose with various degrees of substitution; polyvinyl alcohols with various degrees of saponification and molecular weights; polyelectrolytes, e.g., polyacrylates and especially preferably polystyrenesulfonate, basic polymers and/or copolymer, in particular those having amino groups and/or aminoalkyl groups, imino groups, amido groups or pyridine groups, especially preferably aminoalkyl methacrylate copolymer or N-oxidized polyvinylpyridine.

The separation of different fragrance positions and the controlled dissolution of maximally one layer, preferably exactly one layer containing the active ingredient and thus the targeted release of a defined quantity of active ingredient may be achieved, for example, by the fact that there are barriers layers between the individual layers of active ingredient, these barriers layers preferably having solubility or dispersibility differing from those of the layers containing the active ingredient.

Suitable materials for these barrier layers have already been listed under the terms “system for control of solubility” and “(physico)chemical switch.” To avoid repetition, reference is made here to the corresponding passages of text. Depending on the intended application, preferred barrier layers are those that dissolve/disperse primarily in heated water and thus in the actual wash or treatment cycle as well as barrier layers that are dissolved/dispersed primarily in the rinse cycle due to the lower ionic strength and/or the lower pH.

Barrier layers containing a (physico)chemical switch are preferably used in the inventive detergent or treatment agent portions having several layers containing active ingredient, their active ingredients to be released in a wash cycle or treatment cycle performed using heated water and containing a system for control of the solubility according to the above definition. Examples of suitable active ingredients are the substances already listed above under the heading “basic detergents” or also the bleach components or enzyme components.

Barrier layers having a (physico)chemical switch enable a layer containing active ingredient applied outside of the barrier layer to be dissolved/dispersed in a wash cycle or treatment cycle performed with heated water and to thereby be consumed, but the barrier layer remains intact during the wash cycle or treatment cycle due to the increased ionic strength and/or the elevated pH. In this case, the barrier layer dissolves and/or disperses in the subsequent rinse cycle in which the ionic strength and/or pH decline(s) and thus allows the water to come in contact with the layer containing the active ingredient beneath the barrier layer. If this layer in turn has a greater solubility/dispersibility in a wash cycle or treatment cycle than in a rinse cycle, then the active ingredient contained in this layer is not released until the next wash cycle or treatment cycle.

The barrier layers preferably contain polymeric compounds, especially polycarboxylates and in particular (modified) polyacrylates.

The barrier layers preferably have a thickness of max. 1.0 mm, especially preferably max. 0.7 mm and in particular max. 0.4 mm.

In a preferred embodiment, there is a barrier layer that has a lower water solubility/water dispersibility than the other barrier layers contained in the detergent or treatment agent portion, and this barrier layer is between the core containing the active ingredient and the adjacent layer. The water solubility/water dispersibility of the barrier layers can be controlled, for example, through the degree of crosslinking of the polymers used as the barrier layer component, through the choice of substituents of the polymer backbone as well as the molecular weight of the polymer. The barrier layer between the core containing the active ingredient and the adjacent coating layer preferably does not dissolve/disperse in an aqueous medium until reaching a temperature of at least 30° C., preferably at least 40° C., especially preferably at least 50° C., then preferably at least 60° C. and in particular at least 90° C. Alternatively or additionally, it is possible to provide for the barrier layer between the core containing the active ingredient and the adjacent coating layer to be manually removable.

On the basis of increased user friendliness, it is preferable if the barrier layer between the core containing the active ingredient and the adjacent layer containing the active ingredient is pigmented and thus has an indicator effect. In this way, the consumer is able to recognize when the layers containing the active ingredient in the inventive detergent or treatment agent portion have been consumed and thus the core containing the active ingredient may be used—preferably for care of the automatic washing machine—and a corresponding wash or treatment program of the automatic washing machine can be selected.

An inventive detergent or treatment agent portion preferably has a solubility and/or dispersibility gradient which preferably runs (radially) essentially from the center of the portion and/or the boundary between the optional core containing the active ingredient and the coating layer directly adjacent to the core to the surface of the portion. The solubility and/or the dispersibility of the inventive detergent or treatment agent portion preferably decreases radially in the direction of the surface. A solubility gradient and/or a dispersibility gradient can be implemented most easily by constructing the detergent or treatment agent portion out of multiple coating layers. The coating layers of a detergent or treatment agent portion preferably contain different systems to control the solubility of the respective layer, such that preferably polyethylene glycol and/or paraffins with different molecular weights are used as systems to control the solubility.

The dissolving/dispersing rate of an agent depends on, among other things, the size of the contact surface between the detergent or treatment agent to be dissolved and/or dispersed and the solvent/dispersant. One advantage of the inventive detergent or treatment agent portions with a solubility and/or dispersibility gradient, having a solubility/dispersibility that increases radially from the interior of the portion to the exterior, is the possibility of always releasing comparable amounts of the active ingredients present in the portion despite the decreasing surface of the detergent or treatment agent portion with the number of wash stages or treatment stages, without requiring a concentration gradient of the active ingredients in question within the detergent or treatment agent portion.

In addition, it is preferable that at least one strip, wedge and/or another volume (one or more other faces) is present in the inventive detergent or treatment agent portion, preferably extending radially through one or more coating layers of the detergent portion—but preferably not through the core, which is optionally present—and its composition differs in at least one ingredient or the concentration of at least one ingredient from the composition(s) of the core containing the active ingredient and/or the remaining detergent or treatment agent portion, i.e., the coating layer containing the active ingredient and/or the additional coating layer(s).

It is thus especially preferable that the inventive detergent or treatment agent has essentially the shape of a prism, preferably a cube or an ellipsoid, preferably a spheroid, in particular a flattened or collapsed spheroid or a sphere, and the additional phase(s), preferably in the form of a cylinder, cube, cone or a pyramid, an ellipsoid or an irregular volume, is in the detergent or treatment agent portion, such that the additional phase(s) preferably extend(s) radially in the detergent or treatment agent portion. The additional phase(s) preferably extend(s) essentially from the center of the detergent or treatment agent portion to the surface of the detergent or treatment agent portion, such that the tip of the respective three-dimensional shape (cone, pyramid) is preferably essentially at the center of the detergent or treatment agent portion. The additional phase(s) are thus preferably solid or highly viscous and therefore have dimensional stability.

In a preferred embodiment, the additional phase(s) and the other detergent or treatment agent portion has/have comparable dissolving/dispersing properties. In this way, the active ingredients of the detergent or treatment agent composition and the additional phase(s) are released in the same cycle, i.e., preferably in the wash cycle or treatment cycle. An example of a corresponding inventive detergent or treatment agent portion is a portion which contains a basic detergent in one or more coating layers containing active ingredient and which additionally has at least a volume preferably extending in the form of a cone from the center of the detergent or treatment agent portion to its surface and contains an extra component for a detergent or treatment agent, preferably a fragrance component, an optical brightener and/or a nonionic surfactant. One advantage of these embodiments is the possibility of separating incompatible ingredients which should nevertheless be released simultaneously.

In other preferred embodiment, the additional phase(s) and the other detergent or treatment agent portion have opposing dissolving/dispersing properties, so that the coating layer(s) containing the active ingredient is/are dissolved/dispersed in the wash cycle or treatment cycle, while the other phase(s) release(s) active ingredient in the rinse cycle or vice-versa.

An example of a corresponding inventive detergent or treatment agent portion is a portion which comprises a basic detergent in one or more coating layer(s) containing active ingredient and which additionally has at least a volume that extends preferably in the form of a cone from the center of the detergent or treatment agent portion up to its surface and comprises a component of a detergent or treatment agent, e.g., a bleaching agent.

Another subject matter of the present patent application is a method for producing an inventive detergent or treatment agent portion comprising the following steps:
a) optionally providing a core that contains active ingredient, preferably by means of melt casting, tableting, extrusion or coating of preferably powdered, liquid, pasty or viscous preparations and positioning the core in a mold;
b) casting a free-flowing composition comprising the active ingredients of the detergent or treatment agent in the mold and solidifying the composition to form a dimensionally stable portion; and
c) optionally coating the dimensionally stable portion from step b) with one or more additional layers,
   wherein steps b) and c) preferably take place by hardening free-flowing compositions on the basis of a reduction in temperature, incorporation of water of hydration or other solvent components, reaction of components contained in the free-flowing compositions, conversions of modifications, evaporation of water or other solvent components, condensation, irradiation or by pressing.

Step d) is preferably performed between step a) and step b) and/or between step b) and step c) and/or between several steps c); in this step d), a barrier layer is applied to the respective outer layer of the agent by means of melt solidification, incorporation of water of hydration or other solvent components, reaction of components contained in the barrier material, conversion of modification, evaporation of water or other solvent components, condensation, irradiation or by compression.

The coating of an optional core containing active ingredient with a coating layer containing active ingredient comprising the detergent or treatment agent composition may be performed, for example, by immersing the core in a melt, solution or dispersion containing the ingredients of the detergent or treatment agent their precursor components. It is also possible to secure the core in a mold preferably in the center of the mold and to cast the free-flowing components and/or precursor components of the detergent or treatment agent composition in the mold so that the core is completely surrounded by the cast material. The cast material is preferably hardened by drying to form the inventive portion, i.e., evaporating water or other solvents, incorporation of water of hydration or melt solidification due to a reduction in temperature.

Another possibility for coating the core containing the active ingredient consists of spraying the core with a sprayable preparation containing the components and/or precursor components of the detergent or treatment agent composition.

Additional layers are applied by renewed immersion of the product of method step b) in a melt, solution or dispersion, by introducing the portion (product of method step b)) into a larger mold and filling up this mold by casting the components of the precursor components of the second/third/fourth, etc. coating layer or spraying the portion (product of method step b)) with additional sprayable compositions. Portions comprising multiple coating layers are also produced by a combination of these synthesis methods especially for synthesis of inventive detergent or treatment agent portions with a solubility and/or dispersibility gradient.

In the case of immersion in as well as spraying with a liquid to viscous preparation comprising the (precursor) components of the coating layer(s), it is also possible to powder (dust, roll, blow) the incompletely solidified portions with particulate components.

The subject matter of the present invention also comprises a kit containing an inventive detergent or treatment agent portion and a bag of water-impermeable material or a container that is rigid in at least some areas with one or more openings through which liquids but not the detergent or treatment agent portion in undissolved form, not dispersed and not pulverized, can enter and escape.

The bag and/or the container is preferably at least partially water permeable according to the invention, so that in use of the kit in an automatic washing machine, aqueous solutions and dispersions of the detergents or treatment agent active ingredients can enter and come out through these openings. The diameter of the through-opening for water/wash solution is preferably between 0.1 cm and 1 cm, in particular 0.2 cm and 0.5 cm, so that the exchange of dissolved and/or dispersed components of the detergent or treatment agent portion can take place, but the treatment agent portion in undissolved, undispersed, unpulverized form cannot escape from the coating or the bag. The material of the bag is preferably elastic and conforms to the size of the detergent or treatment agent portion, which decreases with the number of wash stages or treatment stages.

The bag and/or container prevents direct content of the detergent or treatment agent portion with the textiles during the wash stage or treatment stage and in the period of time between the end of the wash stage or treatment stage and removal of the washed or treated textiles from the automatic washing machine by the consumer. In addition, the bag and/or the container controls the dissolving/dispersion of the detergent or treatment agent portion because the surface of the detergent or treatment agent portion comes in contact with less water/wash solution due to its limited liquid passage through the bag/container material than would be the case with direct use of the detergent or treatment agent portion in the wash drum of an automatic washing machine. Additional protection of the detergent or treatment agent portion from the mechanical effects of a wash stage or treatment stage is achieved by introducing elastic material, preferably water-permeable foam or a nonwoven.

The kit especially preferably includes a bag, which contains an inner layer and an outer layer of a mesh-like material and has an intermediate layer of a resilient material, preferably foam, and is preferably elastic.

The bag or the container preferably has a device which allows the coating to be closed. Devices in which a band or a cord is passed through a channel guided along the upper edge of the bag, said edge being gathered and tightened or clamped together.

Another subject matter of the present invention is a method for washing and/or treating textiles in an automatic washing machine, in which an inventive detergent or treatment agent portion or an inventive kit is introduced into the drum of the washing machine and a wash program or treatment program of the washing machine is started.

The inventive detergent or treatment agent portion or the inventive kit is preferably exposed to the water in the drum of the washing machine for 2 to 60 wash stages or treatment stages, preferably 4 to 50 wash stages or treatment stages and in particular 6 to 40 wash stages or treatment stages, such that the phases containing the active ingredient dissolve and/or disperse and the active ingredient contained therein is released.

If the detergent or treatment agent portion includes a basic detergent for white textiles and/or colored textiles, sensitive textiles and/or wool, the portion, preferably in the form of the kit described above, is preferably exposed to the water of 2 to 40 wash stages or treatment stages, preferably 4 to 30 wash stages or treatment stages and in particular 6 to 20 wash stages or treatment stages and/or is also used in an automatic washing machine for textiles in addition to an extra component for a basic detergent, e.g., an enzyme component, a bleach or a finishing component according to the above definition. If the detergent or treatment agent portion contains an extra component for a basic detergent, then the portion, preferably in the form of the kit described, is preferably exposed to the water of 5 to 60 wash stages or treatment stages, preferably 10 to 50 wash stages or treatment stages and in particular 15 to 40 wash stages or treatment stages and/or is also used in an automatic washing machine for textiles in addition to a basic detergent for white textiles and/or colored textiles, sensitive textiles and/or wool.

After essentially complete dissolution and/or dispersion of the detergent or treatment agent portion, the core containing the active ingredient which is optionally present in the inventive method is also dissolved and/or dispersed and preferably the automatic washing machine is disinfected and/or cared for with the active ingredient thereby released. Especially good cleaning and/or care results are obtained when the core is dissolved or dispersed in a wash stage or treatment stage without textiles at a temperature of at least 18° C., preferably at least 30° C., especially preferably at least 40° C., most preferably at least 50° C., most especially preferably at least 60° C. and in particular 90° C. The core containing the active ingredient dissolves/disperses preferably only after a barrier layer between the core containing the active ingredient and the adjacent coating layer has been dissolved and/or dispersed and/or removed manually.

An additional subject matter of the present invention is the use of the inventive detergent or treatment agent portion or an inventive kit for automatic dosing into the drum of an automatic washing machine for textiles.

An inventive detergent or treatment agent portion or the inventive kit is preferably used in 2 to 60 wash stages or treatment stages, preferably 4 to 50 wash stages or treatment stages and in particular 6 to 40 wash stages or treatment stages.

In a preferred embodiment of this invention, a dimensionally stable one-piece detergent or treatment agent portion having a weight of at least 50 g comprising a basic detergent for white textiles and/or colored textiles, sensitive textiles and/or wool as well as a completely enclosed core containing the active ingredient, differing in at least one component or the concentration of at least one component from the composition of the coating layer containing the active ingredient is used alone or together with an extra component for a basic detergent in an automatic washing machine, where it is used for washing and/or treating textiles. The core containing the active ingredient present in the inventive detergent or treatment agent portion is preferably used for care and/or disinfection of the automatic washing machine following the wash stage or treatment stage in which the coating layer containing the active ingredient is dissolved and/or dispersed. The inventive detergent or treatment agent portion—preferably surrounded by a bag—is dosed directly into the drum of the washing machine, where it is left for 2 to 40 wash stages or treatment stages. The extra component for the basic detergent may be dosed though the dispensing compartment or also directly into the drum of the automatic washing machine. The extra component for the basic detergent is preferably also in the form of a dimensionally stable one-piece treatment agent portion having a weight of at least 50 g, making active ingredient available for 5 to 60 wash stages or treatment stages.

In another embodiment of the present invention, a dimensionally stable one-piece detergent or treatment agent portion having a weight of at least 50 g, comprising an extra component for a detergent or treatment agent, preferably an enzyme component, a bleach component or a finishing component and a completely enclosed core containing the active ingredient which differs in at least one component or concentration of at least one component from the composition of the coating layer containing the active ingredient is used alone or together with a basic detergent for white textiles and/or colored textiles, sensitive textiles and/or wool in an automatic washing machine where it is used for washing and/or treatment of textiles. Preferably the core containing the active ingredient in the inventive detergent or treatment agent portion is dissolved and/or dispersed following the wash stages or treatment stages, in which the coating layer containing the active ingredient is dissolved or dispersed, to care for and/or disinfect the automatic washing machine. The inventive detergent or treatment agent portion—preferably enclosed in a bag—is dosed directly into the drum of the washing machine, where it is left for 5 to 60 wash stages or treatment stages. The basic detergent can also be dosed through the rinse chamber or also directly into the drum of the automatic washing machine. The basic detergent is preferably also in the form of a dimensionally stable one-piece treatment agent portion having a weight of at least 50 g, supplying active ingredient for 2 to 40 wash stages or treatment stages.

An inventive detergent or treatment agent portion comprising a basic detergent is preferably used in an automatic washing machine for washing and/or treating textiles. Inventive detergent or treatment agent portions comprising bleach components, enzyme components and/or furnishing components are preferably dosed to the detergent or treatment agent portion comprising the basic detergent as needed, so that these portions are used jointly for washing and/or treating textiles in an automatic washing machine. It may be preferable here to use at least two inventive portions, preferably all the inventive portions that are used in a bag or in a container, or to use each individual portion individually in a container or bag. However, due to possible incompatibilities of the components of the detergent or treatment agent portions or influences of the solubility behavior or dispersion behavior, it is preferable to use the detergent or treatment agent portions individually in a bag or container in the drum of an automatic washing machine.

### EXAMPLES

The solubilities/dispersibilities of the detergent or treatment agent portions E1 and E2 according to the invention as well as those of the comparative portion V (corresponding to the teaching of WO 2005/077064 A2) were determined by means of a standardized solubility/dispersibility test.

### Detergent or Treatment Agent Portion E1 According to the Invention:

The detergent or treatment agent portions E1 and E2 of the compositions given below according to the invention were prepared by combining the components to form a free-flowing composition at 80° C., casting in a mold and allowing the composition to solidify.

| Composition E1 | Composition E2 |
|---|---|
| 17.9 wt % polyethylene glycol | 11.9 wt % paraffin 42-44° C. |
| 12000 | 10.5 wt % polyethylene glycol 12000 |
| 1.9 wt % paraffin 42-44° C. | 10.5 wt % polyethylene glycol 4000 |
| 67.2 wt % extrudate | 67.1 wt % granules |

### Composition of Extrudate and Granules:

33.3 wt % zeolite A
13.6 wt % linear C₁₀₋₁₃ alkylbenzenesulfonate
10.5 wt % water
5.8 wt % sodium citrate.2H₂O
5.7 wt % C₁₂₋₁₈ fatty alcohol sulfate
5.3 wt % C₁₃₋₁₇ fatty alcohol ethoxylate (7 EO)
4.1 wt % sodium bicarbonate
4.1 wt % citric acid
3.8 wt % sodium sulfate
3.8 wt % sodium polycarboxylate
3.3 wt % sodium carbonate
Remainder: lesser ingredients

### Comparative Example V

A portion having the composition given below is prepared by mixing components to form a free-flowing composition at 20° C., then casting in a mold and allowing the composition to solidify.

### Composition VI:

64.4 wt % sodium perborate.4H₂O
13.1 wt % water
9.9 wt % potassium silicate 2.55
3.5 wt % sodium metaborate
3.0 wt % sodium citrate.2H₂O
Remainder: lesser ingredients

### Solubility/Dispersibility Test:

In a glass beaker, 1 L tap water (16° d; iron and manganese ion content less than 0.005 mg/100 mL) is heated to the respective temperature and kept in motion by means of a laboratory stirrer with stirring blades. A sample piece of a defined weight (one intact piece of 7.3 g; no other fragments) is cut out of the respective detergent or treatment agent portion and dosed into the heated water. After stirring for 300 seconds, the solution/dispersion is poured through a screen (mesh 200 μm), then the glass beaker and stirring paddle are rinsed with 5 mL water (tap water 16° d, 10° C.) over the screen, the screen is dried in a drying cabinet at 40° C. until reaching a constant weight, and the residue on the screen is determined by differential weighing. The amount of dissolved/dispersed substance is calculated from the difference between the starting amount of sample and the residue. Triple determinations are performed.

The table shows the solubility/dispersibility in grams per 100 mL water (tap water 16° d).

| | 10° C. | 15° C. | 20° C. | 25° C. | 30° C. | 35° C. | 40° C. | 45° C. | 50° C. | 55° C. | 60° C. |
|---|---|---|---|---|---|---|---|---|---|---|---|
| E1 | 0.10 | 0.09 | 0.09 | 0.11 | 0.14 | 0.15 | 0.21 | 0.60 | 0.63 | 0.61 | 0.73 |
| E2 | 0.10 | 0.17 | 0.14 | 0.17 | 0.17 | 0.21 | 0.30 | 0.58 | 0.71 | 0.70 | 0.73 |
| V | 0.26 | 0.22 | 0.34 | 0.23 | 0.28 | 0.24 | 0.30 | 0.33 | 0.36 | 0.53 | 0.59 |

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation.

1.-17. (canceled)

18. A dimensionally stable one-piece detergent or treatment agent portion having a weight of at least 50 g, comprising a system to control solubility or dispersibility of the detergent or treatment agent in a wash, treatment, or rinse cycle of a washing machine for textiles, wherein a maximum of 50% by weight of the portion dissolves or disperses in 16° d tap water at a maximum temperature of 20° C. as dissolves or disperses in 16° d tap water at 50° C. under identical conditions.

19. The detergent or treatment agent portion of claim 18, having a solubility or dispersibility in 16° d tap water at 15° C. of less than 0.2 g/100 mL water, and a solubility or dispersibility in 16° d tap water at 50° C. of more than 0.35 g/100 mL water.

20. The detergent or treatment agent portion of claim 19, having a solubility or dispersibility in 16° d tap water at 15° C. of less than 0.1 g/10 mL water, and a solubility or dispersibility in 16° d tap water at 50° C. of greater than 0.12 g/100 mL water.

21. The detergent or treatment agent portion of claim 18, wherein the system to control the solubility or dispersibility of the detergent or treatment agent comprises at least 5% by weight of the portion.

22. The detergent or treatment agent portion of claim 18, wherein the system to control the solubility or dispersibility of the detergent or treatment agent comprises one or more polyethylene glycols, polypropylene glycols, polybutyrates, polyvalent alcohols, sugars, polyurethanes, natural waxes, chemically modified waxes, synthetic waxes, wax alcohols, wax esters, paraffins, polyvinyl alcohols, polyacrylic acids and their derivatives, gelatin, or celluloses.

23. The detergent or treatment agent portion of claim 18, comprising at least 6% by weight of one or more surfactants.

24. The detergent or treatment agent portion of claim 18, comprising a basic detergent for white, colored, sensitive, or wool textiles.

25. The detergent or treatment agent portion of claim 18, further comprising a bleach component, an enzyme, a finishing component, an antimicrobial active ingredient, or a nonionic surfactant.

26. The detergent or treatment agent portion of claim 18, having a weight of 75 g to 1500 g.

27. A method for producing a detergent or treatment agent portion, comprising the steps of:
a) optionally providing a core containing an active ingredient by melt casting, tableting, extruding, or coating a powdered, liquid, pasty, or viscous preparation comprising the active ingredient and positioning the core in a mold;
b) casting in the mold a free-flowing composition comprising an active ingredient that is the same or different from, where present, the active ingredient contained in the core, and solidifying the composition to form a dimensionally stable portion; and
c) optionally coating the dimensionally stable portion from step b) with one or more additional layers,
wherein steps b) and c) comprise curing a free-flowing composition by lowering its temperature, incorporating water of hydration or other solvent components, reacting components in the free-flowing composition, chemical conversion or modification, evaporating water or other solvent components, condensation, irradiation, or compression.

28. The method of claim 27, further comprising the step of applying a barrier layer to a respective outer layer of the portion by melt solidification, incorporation of water of hydration or other solvent components, reaction of components present in the barrier material, chemical conversion or modification, evaporation of water or other solvent components, condensation, irradiation, or compression.

29. A kit comprising the detergent or treatment agent portion of claim 18 and a bag of water-permeable material or a container that is rigid in at least some areas and has one or more openings through which liquids but not the detergent portion in undissolved, undispersed, or unpulverized form can enter and leave.

30. The kit of claim 29, wherein the bag or container comprises a device that allows the bag or container to be closed or comprises a cushioning material.

31. A method of washing, treating, or rinsing a textile comprising providing the detergent or cleaning agent portion of claim 18 in an automatic washing machine drum and dosing the detergent or cleaning agent from the portion to wash, treat, or rinse the textile.

32. The method of claim 31, wherein the portion is used in 2 to 60 washing, treating, or rinsing stages.

33. A method of washing, treating, or rinsing a textile comprising providing the kit of claim 29 in an automatic washing machine drum and dosing the detergent or cleaning agent from the portion to wash, treat, or rinse the textile.

34. The method of claim 33, wherein the kit is used in 2 to 60 washing, treating, or rinsing stages.

35. The detergent or cleaning portion of claim 18, capable of use in 2 to 60 washing, treating, or rinsing stages.
